(19) United States
(12) Patent Application Publication
(10) Pub. No.: US 2024/0361131 A1
(43) Pub. Date: Oct. 31, 2024

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventors: JOJI KAMAHARA, Tokyo (JP); HIRONORI FUKUCHI, Kanagawa (JP); YOHEI SATO, Kanagawa (JP)

(21) Appl. No.: 18/764,509

(22) Filed: Jul. 5, 2024

Related U.S. Application Data
(63) Continuation-in-part of application No. PCT/JP2023/002161, filed on Jan. 24, 2023.

(30) Foreign Application Priority Data
Feb. 1, 2022 (JP) 2022-014166
Jun. 28, 2022 (JP) 2022-103849
Jan. 16, 2023 (JP) 2023-004385

(51) Int. Cl. G01C 21/34; G05D 1/246; G05D 107/10

(52) U.S. Cl. CPC G01C 21/34; G05D 1/2462; G05D 2107/10

(57) ABSTRACT

An information processing device that can hierarchically divide and manage a three-dimensional space includes: a storage unit configured to store unique identifiers allocated to a plurality of first spatial subareas with a first size in a three-dimensional space and unique identifiers allocated to a plurality of second spatial subareas with a second size smaller than the first size in the first spatial subareas; and a control unit configured to store spatial information on internal states of the plurality of first spatial subareas and the plurality of second spatial subareas in the storage unit in association with the corresponding unique identifiers.

### BACKGROUND

### Field

The present invention relates to an information processing device, an information processing method, and a storage medium.

### Description of the Related Art

With recent technological innovations such as an autonomous traveling mobile object and a spatial recognition system in the world, an overall view (hereinafter referred to as a digital architecture) connecting data or systems among members of different organizations or societies has been developed.

For example, in Japanese Patent Laid-Open No. 2014-002519, a single processor divides a spatiotemporal area into time and space on the basis of spatiotemporal management data provided by a user and generates a plurality of spatiotemporal subareas. The processor allocates identifiers which are expressed by one-dimensional integer values for uniquely identifying the plurality of spatiotemporal subareas in consideration of the neighborhood of time and space of the spatiotemporal subareas.

A spatiotemporal data management system that determines an arrangement of time-series data such that data of spatiotemporal subareas of which the identifiers are close to each other are arranged close to each other in a storage device has been disclosed.

However, in Japanese Patent Laid-Open No. 2014-002519 only the processor having generated data can ascertain data on the generated subareas using the identifiers. Accordingly, users of different systems cannot utilize information on the spatiotemporal subareas.

### SUMMARY OF THE DISCLOSURE

According to an aspect of the present invention, there is provided an information processing device including: at least one processor or circuit configured to function as: a storage unit configured to store unique identifiers allocated to a plurality of first spatial subareas with a first size in a three-dimensional space, and height and unique identifiers allocated to a plurality of second spatial subareas with a second size smaller than the first size in the first spatial subareas; and a control unit configured to store spatial information on internal states of the plurality of first spatial subareas and the plurality of second spatial subareas in the storage unit in association with the corresponding unique identifiers.

Further features of the present disclosure will become apparent from the following description of embodiments with reference to the attached drawings.

### BRIEF DESCRIPTION OF THE DRAWINGS

FIG. 1 is a diagram illustrating an example of an entire configuration of an autonomous mobility control system according to a first embodiment of the present invention.

FIG. 2A is a diagram illustrating an example of an input screen for allowing a user to input position information and FIG. 2B is a diagram illustrating an example of a selection screen for selecting an autonomous mobility to be used.

FIG. 3A is a diagram illustrating an example of a screen for ascertaining a current location of an autonomous mobility and FIG. 3B is a diagram illustrating an example of a map display screen used to ascertain the current location of the autonomous mobility.

FIG. 4 is a functional block diagram illustrating an example of internal configurations of 10 to 15 in FIG. 1.

FIG. 5A is a diagram illustrating a spatial positional relationship between an autonomous mobility 12 in the real world and a pillar 99 which is present as a nearby geographical feature and FIG. 5B is a diagram illustrating a state in which the autonomous mobility 12 and the pillar 99 are mapped on an arbitrary XYZ coordinate system space with P0 as an origin.

FIG. 6 is a perspective view illustrating an example of a mechanical configuration of an autonomous mobility 12 according to the first embodiment.

FIG. 7 is a block diagram illustrating an example of specific hardware configurations of a control unit 10-2, a control unit 11-2, a control unit 12-2, a control unit 13-2, a control unit 14-3, and a control unit 15-2.

FIG. 8 is a sequence diagram illustrating a process flow that is performed by the autonomous mobility control system according to the first embodiment.

FIG. 9 is a sequence diagram subsequent to FIG. 8.

FIG. 10 is a sequence diagram subsequent to FIG. 9.

FIG. 11A is a diagram illustrating latitude and longitude information of the global and FIG. 11B is a perspective view illustrating a predetermined space 100 in FIG. 11A.

FIG. 12 is a diagram schematically illustrating spatial information in the space 100.

FIG. 13A is a diagram illustrating route information displayed on map information, FIG. 13B is a diagram illustrating route information using positional point group data displayed on map information, and FIG. 13C is a diagram illustrating route information using unique identifiers displayed on map information.

FIG. 14 is a diagram illustrating an example of a hierarchical structure of voxels according to a second embodiment.

FIG. 15 is a diagram illustrating an example of spatial information associated with small voxels arranged in a space.

FIG. 16 is a flowchart illustrating a process flow of acquiring object information from a map database and storing the object information in association with small voxels.

FIG. 17 is a diagram illustrating an example of spatial information associated with middle voxels arranged in a space.

FIG. 18 is a flowchart illustrating a process flow of generating and storing object information of each middle voxel on the basis of object information of a plurality of small voxels.

FIG. 19 is a diagram illustrating an example of spatial information associated with large voxels arranged in a space.

FIG. 20 is a flowchart illustrating a process flow of generating and storing object information of each large voxel on the basis of object information of a plurality of middle voxels.

FIG. 21 is a flowchart illustrating a process flow of acquiring object information from a map database and storing the object information in association with large voxels, middle voxels, and small voxels in this order.

FIG. 22 is a flowchart subsequent to FIG. 21.

FIG. 23 is a diagram illustrating an example in which weather information is included as spatial information associated with large voxels arranged in a space.

FIG. 24 is a flowchart illustrating a process flow of acquiring weather information from a weather information database and storing the weather information in association with large voxels, middle voxels, and small voxels.

FIG. 25A is a diagram illustrating an example in which a plurality of small voxels included in two neighboring middle voxels in the hierarchical structure of voxels according to the second embodiment are selected and a virtual middle voxel IVM is determined, and FIG. 25B is a diagram illustrating an example in which a plurality of small voxels included in four neighboring middle voxels in the hierarchical structure of voxels according to the second embodiment are selected and a virtual middle voxel IVM is determined.

FIGS. 26A and 26B are diagrams illustrating an example of voxels that are arranged in a lane when an autonomous mobility moves.

FIGS. 27A and 27B are diagrams illustrating an example in which virtual voxels are arranged on a center line 1001 of a lane.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

In the embodiments, it is assumed that the present invention is applied to control of an autonomous mobility (autonomous mobile object, or autonomous mobile body), but the autonomous mobility (autonomous mobile object, or autonomous mobile body) may be a mobile object of which at least a part in movement of the mobile object can be operated by a user. That is, the embodiments may be applied to, for example, a configuration in which various types of information on a moving route or the like are displayed to a user and the user performs some operations of the mobile object with reference to the display of information.

### First Embodiment

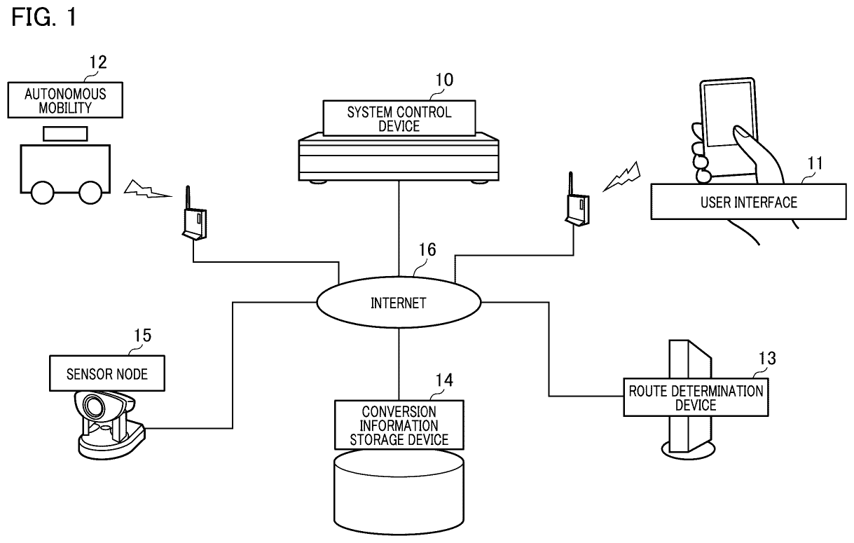

FIG. 1 is a diagram illustrating an example of an entire configuration of an autonomous mobility control system according to a first embodiment of the present invention. As illustrated in FIG. 1, an autonomous mobility control system according to this embodiment (which may be abbreviated to a control system) includes a system control device 10, a user interface 11, an autonomous mobility 12 (mobility), a route determination device 13, a conversion information storage device 14, and a sensor node 15. Here, the user interface 11 refers to a user terminal device.

In this embodiment, the devices illustrated in FIG. 1 are connected to each other by network connection units thereof which will be described later via the Internet 16. However, for example, another network system such as a local area network (LAN) may be used.

Some of the system control device 10, the user interface 11, the route determination device 13, and the conversion information storage device 14 may be constituted as the same device.

Each of the system control device 10, the user interface 11, the autonomous mobility 12, the route determination device 13, the conversion information storage device 14, and the sensor node 15 includes an information processing device including a CPU which is a computer and a ROM, a RAM, and an HDD which are storage media. Details of functions and internal configurations of the devices will be described later.

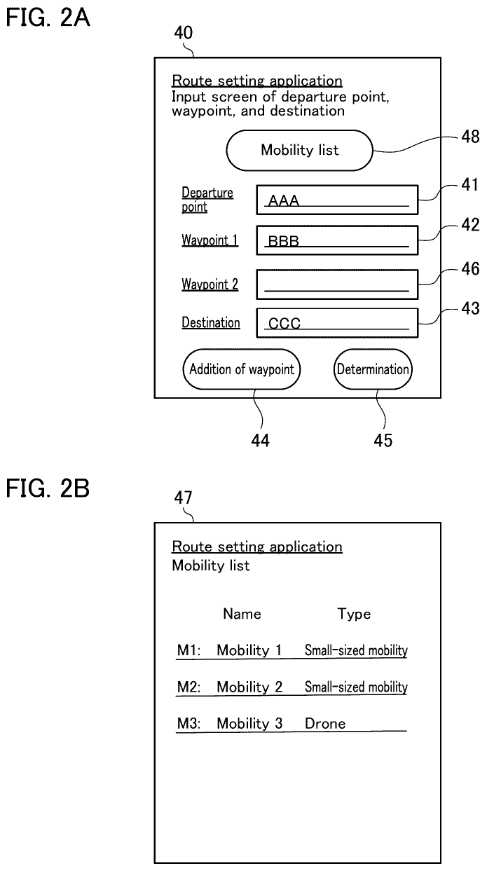

Service application software (hereinafter abbreviated to an application) that is provided by the autonomous mobility control system will be described below. A screen image that is displayed by the user interface 11 when a user inputs position information will be first described below with reference to FIGS. 2A and 2B.

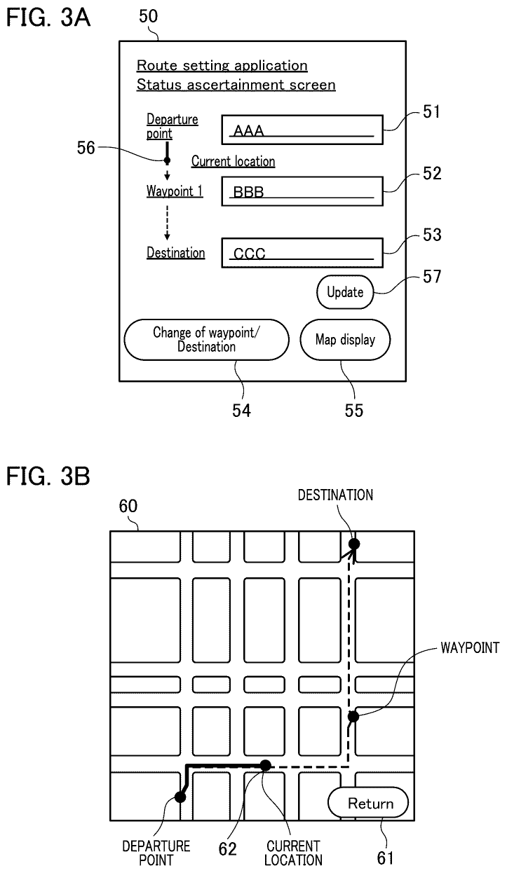

A screen image that is displayed by the user interface 11 when a user views a current location of the autonomous mobility 12 will be then with reference to FIGS. 3A and 3B. How the application is operated in the autonomous mobility control system will be described with reference to an example.

In this description, it is assumed that a map is a two-dimensional plane for the purpose of convenience, but a user may designate a three-dimensional position including “height” and input “height” information in this embodiment. That is, according to this embodiment, It is possible to generate a three-dimensional map.

FIG. 2A is a diagram illustrating an example of an input screen when a user inputs position information, and FIG. 2B is a diagram illustrating an example of a selection screen for selecting an autonomous mobility to be used. When a user operates a display screen of the user interface 11, accesses the Internet 16, and selects, for example, a route setting application for the autonomous mobility control system, a WEB page of the system control device 10 is displayed.

An input screen 40 of a departure point, waypoints, and a destination for setting the departure point, the waypoints, and the destination when the autonomous mobility 12 is made to move is first displayed in the WEB page. When a list display button 48 for displaying a list of autonomous mobilities (mobile object) to be used is included in the input screen 40 and a user pushes the list display button 48, a list display screen 47 of mobilities is displayed as illustrated in FIG. 2B.

The user selects an autonomous mobility to be used via the list display screen 47. For example, mobilities M1 to M3 are selectably displayed on the list display screen 47, but the number of mobilities is not limited thereto.

When the user selects one of mobilities M1 to M3 through a clicking operation or the like, the display screen returns automatically to the input screen 40 illustrated in FIG. 2A. A name of the selected mobility is displayed on the list display button 48. Thereafter, the user inputs a place which is set as a departure point to an input field 41 of “departure.”

The user inputs a place which is set as a waypoint to an input field 42 of “waypoint 1.” When a waypoint can be added and an addition button 44 of a waypoint is pushed one time, an input filed 46 of “waypoint 2” is additionally displayed and the user can input a waypoint to be added.

Whenever the user pushes the addition button 44 of a waypoint, input fields 46 of “waypoint 3” and “waypoint 4” are additionally displayed and the user can input a plurality of waypoints to be input. The user inputs a place which is set as a destination to an input field 43 of “destination.” Although not illustrated in the drawing, when the input fields 41 to 43 and 46 and the like are clicked, a keyboard for inputting characters or the like is temporarily displayed to enable desired characters to be input.

The user can set a moving route of the autonomous mobility 12 by pushing a determination button 45. In the example illustrated in FIG. 2, “AAA” is set as the departure point, “BBB” is set as the waypoint 1, and “CCC” is set as the destination. Words to be input to the input field may be, for example, addresses or may be position information indicating a specific position such as latitude/longitude information, a store name, or a phone number.

FIG. 3A is a diagram illustrating an example of a screen for ascertaining a current location of the autonomous mobility and FIG. 3B is a diagram illustrating an example of a map display screen used to ascertain the current location of the autonomous mobility.

Reference sign 50 in FIG. 3A denotes an ascertainment screen and is displayed by operating an operation button which is not illustrated after the moving route of the autonomous mobility 12 has been set on the screen illustrated in FIG. 2A.

On the ascertainment screen 50, the current location of the autonomous mobility 12 is displayed in a WEB page of the user interface 11 like a current location 56. Accordingly, the user can easily ascertain the current location.

The user can update screen display information and display a newest state by pushing an update button 57. The user can change the departure point, the waypoint, and the destination by pushing a waypoint/destination change button 54. That is, the user can change the departure point, the waypoint, and the destination by inputting places to be reset to an input field 51 of “departure point,” an input field 52 of “waypoint 1,” and an input filed 53 of “destination.”

FIG. 3B illustrates an example of a map display screen 60 to which the ascertainment screen 50 is switched when a map display button 55 illustrated in FIG. 3A is pushed. By displaying a position of the current location 62 on a map in the map display screen 60, the user can more easily ascertain the current location of the autonomous mobility 12. When the user pushes a return button 61, the display screen can be returned to the ascertainment screen 50 illustrated in FIG. 3A.

As described above, the user can easily set a moving route along which the autonomous mobility 12 moves from a predetermined place to a predetermined place through operating of the user interface 11. This route setting application can also be applied to, for example, a taxi allocation service or a drone delivery service

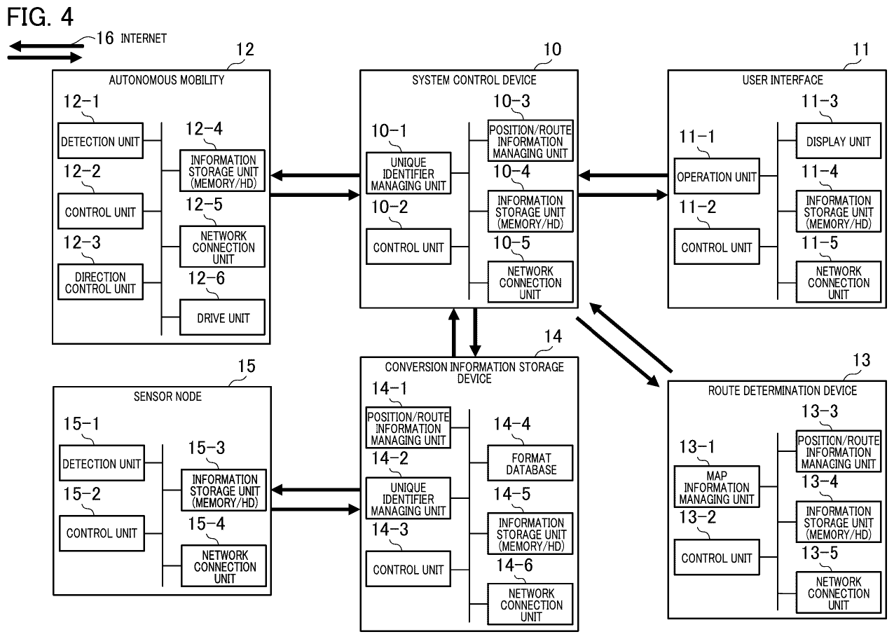

A configuration example and a function example of reference signs 10 to 15 in FIG. 1 will be described below in detail with reference to FIG. 4. FIG. 4 is a functional block diagram illustrating an example of internal configurations of reference signs 10 to 15 in FIG. 1. Some functional blocks illustrated in FIG. 4 are realized by causing a computer (not illustrated) included in the corresponding devices to execute a computer program stored in a memory which is a storage medium which is not illustrated.

However, some or all of the functional blocks may be realized by hardware. A dedicated circuit (ASIC), a processor (a reconfigurable processor or a DSP), or the like can be used as the hardware.

The functional blocks illustrated in FIG. 4 may not be incorporated into the same casing and may be constituted by different devices connected to each other via a signal line.

In FIG. 4, the user interface 11 includes an operation unit 11-1, a control unit 11-2, a display unit 11-3, an information storage unit (memory/HD) 11-4, and a network connection unit 11-5.

The operation unit 11-1 is constituted by a touch panel, key buttons, or the like and is used to input data. The display unit 11-3 is, for example, a liquid crystal screen and is used to display route information or other data.

The display screen of the user interface 11 illustrated in FIGS. 2 and 3 is displayed on the display unit 11-3. The user can perform selection of a route, inputting of information, ascertainment of information, and the like using a menu displayed on the display unit 11-3. That is, the operation unit 11-1 and the display unit 11-3 provide an operation interface for allowing a user to perform actual operation. Instead of separately providing the operation unit 11-1 and the display unit 11-3, the operation unit and the display unit may share a touch panel.

The control unit 11-2 has a CPU which is a computer built thereinto, performs mode management such as management of various applications, inputting of information, and ascertainment of information in the user interface 11, and controls a communication process. The control unit 11-2 also controls processes in constituent units of the system control device.

The information storage unit (memory/HD) 11-4 is, for example, a database for storing necessary information such as a computer program that is executed by the CPU. The network connection unit 11-5 controls communication that is performed via the Internet, a LAN, a wireless LAN, or the like. For example, the user interface 11 may be a device such as a smartphone or may be of a type such as a tablet terminal.

In this way, the user interface 11 according to this embodiment displays the input screen 40 including the departure point, the waypoint, and the destination on a browser screen of the system control device 10, and thus a user can input position information such as the departure point, the waypoint, and the destination. By displaying the ascertainment screen 50 and the map display screen 60 on the browser screen, it is possible to display the current location of the autonomous mobility 12.

In FIG. 4, the route determination device 13 includes a map information managing unit 13-1, a control unit 13-2, a position/route information managing unit 13-3, an information storage unit (memory/HD) 13-4, and a network connection unit 13-5. The map information managing unit 13-1 stores wide map information, searches for route information indicating a route on a map on the basis of designated predetermined position information, and transmits route information as a search result to the position/route information managing unit 13-3.

The map information is three-dimensional map information including information such as tomography or latitude/longitude/altitude and also includes regulation information associated with the Road Traffic Act such as roadways, walkways, traveling directions, and traffic regulations.

The map information includes, for example, traffic regulation information varying with time such as one-way passing in some time periods or pedestrian-only roads in some time periods along with the time information. The control unit 13-2 has a CPU which is a computer built thereinto and controls processes in the constituent units of the route determination device 13.

The position/route information managing unit 13-3 manages position information of an autonomous mobility acquired via the network connection unit 13-5, transmits the position information to the map information managing unit 13-1, and manages the routine information as the search result acquired from the map information managing unit 13-1. The control unit 13-2 converts the route information managed by the position/route information managing unit 13-3 to a predetermined data format in response to a request from an external system and transmits the resultant route information to the external system.

As described above, in this embodiment, the route determination device 13 is configured to search for a route based on the Road Traffic Act on the basis of the designated position information and to output the routine information in a predetermined data format.

In FIG. 4, the conversion information storage device 14 includes a position/route information managing unit 14-1, a unique identifier managing unit 14-2, a control unit 14-3, a format database 14-4, an information storage unit (memory/HD) 14-5, and a network connection unit 14-6.

The conversion information storage device 14 can serve as a formatting unit configured to allocate a unique identifier to a three-dimensional space defined by latitude, longitude, and altitude and to format and store spatial information on a state of an object in the space and time in association with the unique identifier.

The position/route information managing unit 14-1 manages predetermined position information acquired via the network connection unit 14-6 and transmits the position information to the control unit 14-3 in response to the control unit 14-3. The control unit 14-3 has a CPU which is a computer built thereinto and controls processes in the constituent units of the conversion information storage device 14.

The control unit 14-3 converts the position information to a unique identifier defined in the aforementioned format on the basis of the position information acquired from the position/route information managing unit 14-1 and information of formats managed in the format database 14-4. The control unit 14-3 transmits the unique identifier to the unique identifier managing unit 14-2.

The formatting will be described later in detail, and the formatting is to allocate an identifier (hereinafter referred to as a unique identifier) to a space with a predetermined position as an origin and to manage the space using the unique identifier. In this embodiment, it is possible to acquire the corresponding unique identifier or information in the corresponding space on the basis of predetermined position information.

The unique identifier managing unit 14-2 manages the unique identifier subjected to conversion in the control unit 14-3 and transmits the unique identifier via the network connection unit 14-6. The format database 14-4 manages information of the format and transmits the information of the format to the control unit 14-3 in response to a request from the control unit 14-3.

The control unit 14-3 manages the information in the space acquired via the network connection unit 14-6 using the format. The conversion information storage device 14 manages the information on the space acquired by an external instrument, device, or network in association with the unique identifier. The conversion information storage device 14 provides the unique identifier and the information on the space associated therewith to the external instrument, device, or network.

As described above, the conversion information storage device 14 acquires the unique identifier and the information in the space on the basis of predetermined position information and manages and provides the information in a state in which the external instrument, device, or network connected thereto can be shared. The conversion information storage device 14 converts the position information designated by the system control device 10 to a unique identifier and provides the unique identifier to the system control device 10.

In FIG. 4, the system control device 10 includes a unique identifier managing unit 10-1, a control unit 10-2, a position/route information managing unit 10-3, an information storage unit (memory/HD) 10-4, and a network connection unit 10-5. The position/route information managing unit 10-3 stores simple map information in which tomography information and latitude/longitude information are correlated and manages predetermined position information and route information acquired via the network connection unit 10-5.

The position/route information managing unit 10-3 divides the route information at predetermined intervals and may generate position information which is latitude/longitude of each divided place. The unique identifier managing unit 10-1 manages information obtained by converting the position information and the route information to the unique identifier.

The control unit 10-2 has a CPU which is a computer built thereinto, takes charge of control of a communication function of the position information, the route information, and the unique identifier in the system control device 10, and controls processes in the constituent units of the system control device 10.

The control unit 10-2 provides a WEB page to the user interface 11 and transmits predetermined position information acquired from the WEB page to the route determination device 13. The control unit 10-2 also acquires predetermined route information from the route determination device 13 and transmits position information of the route information to the conversion information storage device 14. The control unit 10-2 transmits the route information converted to the unique identifier and acquired from the conversion information storage device 14 to the autonomous mobility 12.

As described above, the system control device 10 is configured to perform acquisition of predetermined position information designated by a user, transmission and reception of position information and route information, generation of position information, and transmission and reception of route information using a unique identifier.

The system control device 10 collects the route information required for the autonomous mobility 12 to move autonomously on the basis of the position information input to the user interface 11 and provides the route information using a unique identifier to the autonomous mobility 12. In this embodiment, the system control device 10, the route determination device 13, and the conversion information storage device 14 serve as, for example, servers.

In FIG. 4, the autonomous mobility 12 includes a detection unit 12-1, a control unit 12-2, a direction control unit 12-3, an information storage unit (memory/HD) 12-4, a network connection unit 12-5, and a drive unit 12-6. The detection unit 12-1 includes, for example, a plurality of imaging elements and has a function of measuring a distance on the basis of phase differences among a plurality of imaging signals acquired from the plurality of imaging elements.

The detection unit 12-1 has a self-position estimating function of acquiring detection information such as nearby tomography and obstacles such as walls of buildings (hereinafter referred to as detection information) and estimating a self-position on the basis of the detection information and map information.

The detection unit 12-1 has a self-position detecting function such as a global positioning system (GPS) and a direction detecting function such as a geomagnetic sensor. The control unit 12-2 can generate a three-dimensional map in a cyber space on the basis of the acquired detection information, the acquired self-position estimation function, and the acquired direction detection information.

Here, a three-dimensional map in a cyber space can express spatial information equivalent to geographical feature positions in the real world as digital data. In a three-dimensional map in a cyber space, an autonomous mobility 12 present in the real world or nearby geographical feature information is stored as digital data and as spatially equivalent information. Accordingly, efficient movement is possible using the digital data.

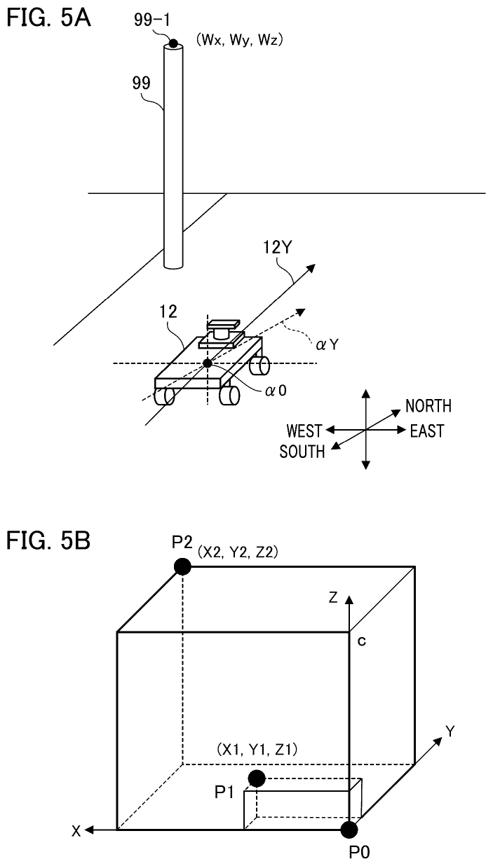

A three-dimensional map in a cyber space that is used in this embodiment will be described below with reference to FIG. 5. FIG. 5A is a diagram illustrating a spatial positional relationship between an autonomous mobility 12 in the real world and a pillar 99 which is present as a nearby geographical feature, and FIG. 5B is a diagram illustrating a state in which the autonomous mobility 12 and the pillar 99 are mapped on an arbitrary XYZ coordinate system space with a position P0 as an origin.

In FIGS. 5A and 5B, a position of an autonomous mobility 12 is identified as a position α0 in the autonomous mobility 12 from position information of latitude and longitude acquired by a GPS or the like which is not illustrated and which is mounted in the autonomous mobility 12. The azimuth of the autonomous mobility 12 is identified by a difference between an azimuth αY acquired by an electronic compass which is not illustrated and a moving direction 12Y of the autonomous mobility 12.

The position of the pillar 99 is identified as a position of a top 99-1 from pre-measured position information. A distance from the position α0 in the autonomous mobility 12 to the top 99-1 can be acquired using a distance measuring function of the autonomous mobility 12. In FIG. 5A, when the moving direction 12Y is defined as an axis of an XYZ coordinate system and α0 is defined as an origin, the position is represented by coordinates (Wx, Wy, Wz) of the top 99-1.

In the three-dimensional map in a cyber space, the acquired information is managed as digital data and can be reconfigured as spatial information illustrated in FIG. 5B by the system control device 10, the route determination device 13, or the like. In FIG. 5B, a state in which the autonomous mobility 12 and the pillar 99 are mapped on an arbitrary XYZ coordinate system space with P0 as an origin is illustrated.

By setting P0 to predetermined latitude and longitude in the real world and setting the north in the real world to the Y-axis direction, the autonomous mobility 12 can be represented by P1 and the pillar 99 can be represented by P2 in the arbitrary XYZ coordinate system space.

Specifically, the position P1 of α0 in this space can be calculated on the basis of the latitude and longitude of α0 and the latitude and longitude of P0. Similarly, the position of the pillar 99 can be calculated as P2. In this example, two objects including the autonomous mobility 12 and the pillar 99 are expressed in the three-dimensional map in a cyber space, and even more objects can be handled in the same way. As described above, a three-dimensional map is obtained by mapping a self-position or an object in the real world onto a three-dimensional space.

Referring back to FIG. 4, the autonomous mobility 12 stores learning result data of object detection using machine learning, for example, in the information storage unit (memory/HD) 12-4 and can detect an object from a captured image using machine learning. The detection information may be acquired from an external system via the network connection unit 12-5 and reflected in the three-dimensional map.

The control unit 12-2 has a CPU which is a computer built thereinto, takes charge of movement, direction change, and an autonomous traveling function of the autonomous mobility 12, and controls processes in the constituent units of the autonomous mobility 12.

The direction control unit 12-3 changes the moving direction of the autonomous mobility 12 by changing a driving direction of the mobility using the drive unit 12-6. The drive unit 12-6 includes a drive device such as a motor and generates a thrust of the autonomous mobility 12. The autonomous mobility 12 can reflect the self-position, the detection information, and the object detection information in the three-dimensional map, generate a route holding a constant gap from nearby tomography, buildings, obstacles, and objects, and perform autonomous traveling.

The route determination device 13 generates a route mainly in consideration of regulation information associated with the Road Traffic Act. On the other hand, the autonomous mobility 12 more accurately detects a position of a nearby obstacle in the route generated by the route determination device 13 and generates a route for movement without any contact therewith on the basis of its own size.

A mobility type of the autonomous mobility may be stored in the information storage unit (memory/HD) 12-4 of the autonomous mobility 12. The mobility type is, for example, a type of a mobile object which legally identified and unit a type such as an automobile, a bicycle, or a drone. It is possible to generate formatted route information which will be described later on the basis of the mobility type.

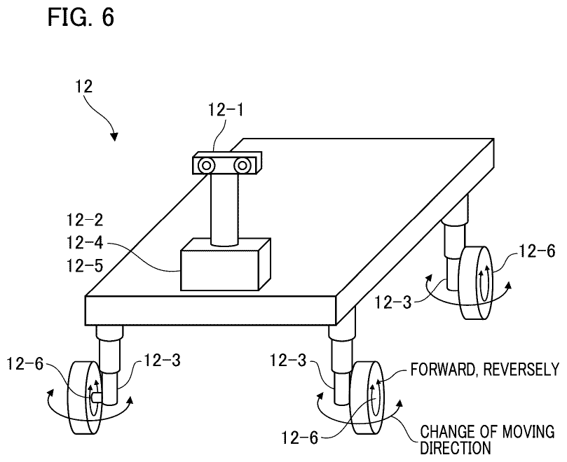

An example of a configuration of a main body of the autonomous mobility 12 in this embodiment will be described below with reference to FIG. 6. FIG. 6 is a perspective view illustrating an example of a mechanical configuration of the autonomous mobility 12 according to the first embodiment. In this embodiment, the autonomous mobility 12 is assumed to be a traveling body including wheels, but may be a flying object such as a drone.

In FIG. 6, the detection unit 12-1, the control unit 12-2, the direction control unit 12-3, the information storage unit (memory/HD) 12-4, the network connection unit 12-5, and the drive unit 12-6 are mounted in the autonomous mobility 12, and the constituent units are electrically connected to each other. Two or more drive units 12-6 and two or more direction control units 12-3 are provided in the autonomous mobility 12.

The direction control unit 12-3 changes the moving direction of the autonomous mobility 12 by changing the direction of the drive unit 12-6 through rotational driving of a shaft, and the drive unit 12-6 performs forward and reverse movement of the autonomous mobility 12 through rotation of a shaft. The configuration described above with reference to FIG. 6 is an example, and the present invention is not limited thereto. For example, change of the moving direction may be performed using omni-wheels.

The autonomous mobility 12 is a mobile object, for example, using simultaneous localization and mapping (SLAM) technology. The autonomous mobility 12 is configured to move autonomously along a designated predetermined route on the basis of the detection information detected by the detection unit 12-1 or the like and the detection information of an external system acquired via the Internet 16.

The autonomous mobility 12 can perform trace movement in which the autonomous mobility 12 traces points which are finely designated and can also move while passing through roughly set points and generating route information in spaces therebetween. As described above, the autonomous mobility 12 according to this embodiment can move autonomously on the sis of route information using a unique identifier provided by the system control device 10.

Referring back to FIG. 4, the sensor node 15 is, for example, an external system such as a video monitoring system including a roadside camera unit and includes a detection unit 15-1, a control unit 15-2, an information storage unit (memory/HD) 15-3, and a network connection unit 15-4. The detection unit 15-1 is, for example, a camera, acquires detection information of an area which can be detected by itself, and has an object detecting function and a distance measuring function.

The control unit 15-2 has a CPU which is a computer built thereinto, takes charge of control of a detection function in the sensor node 15, a data storage function, and a data transmitting function, and controls processes in the constituent units in the sensor node 15. The control unit 15-2 stores the detection information acquired by the detection unit 15-1 in the information storage unit (memory/HDD) 15-3 and transmits the detection information to the conversion information storage device 14 via the network connection unit 15-4.

As described above, the sensor node 15 is configured to store detection information such as image information detected by the detection unit 15-1 and feature point information and position information of a detected object in the information storage unit 15-3 and to transmit the detection information. The sensor node 15 provides the detection information of the area which can be detected by itself to the conversion information storage device 14.

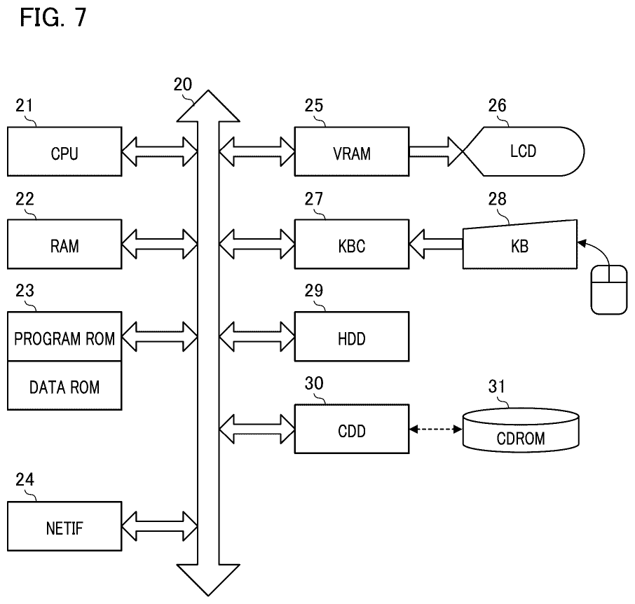

A specific hardware configuration of the control units in FIG. 4 will be described below. FIG. 7 is a block diagram illustrating an example of a specific hardware configuration of the control unit 10-2, the control unit 11-2, the control unit 12-2, the control unit 13-2, the control unit 14-3, and the control unit 15-2. The control units are not limited to the hardware configurations illustrated in FIG. 7. The control units does not have to include all the blocks illustrated in FIG. 7.

In FIG. 7, reference sign 21 denotes a CPU which is a computer tacking charge of calculation and control of the information processing device. Reference sign 22 denotes a RAM and serves as a main memory of the CPU 21, an area of an execution program or an execution area of the program, and a data area. Reference sign 23 denotes a ROM storing operation processing sequences of the CPU 21.

The ROM 23 includes a program ROM in which basic software (OS) which is a system program for controlling the information processing device is stored and a data ROM in which information required for operating the system or the like is stored. An HDD 29 which will be described later may be used instead of the ROM 23.

Reference sign 24 denotes a network interface (NETIF) and performs control for transmitting data between information processing devices via the Internet 16 or diagnosis of a connection situation. Reference sign 25 denotes a video RAM (VRAM) that loads an image to be displayed on a screen of an LCD 26 and control display thereof. Reference sign 26 denotes a display device such as a display (hereinafter, referred to as an LCD).

Reference sign 27 denotes a controller (hereinafter, referred to as a KBC) for controlling an input signal from an external input device 28. Reference sign 28 denotes an external input device (hereinafter, referred to as a KB) for receiving an operation performed by a user and, for example, a keyboard and a pointing device such as a mouse are used.

Reference sign 29 denotes a hard disk drive (hereinafter, referred to as an HDD) and is used to store application programs or various types of data. An application program in this embodiment is a software program for performing various processing functions in this embodiment.

Reference sign 30 denotes an external input/output device (hereinafter, referred to as a CDD). For example, this device is for inputting and outputting data to and from a removable medium 31 which is a detachable data recording medium such as a CD-ROM drive, a DVD drive, or a Blu-Ray (registered trademark), disk drive.

The CDD 30 is used to read the application program from a removable medium or the like. Reference sign 31 denotes a removable medium such as a CD-ROM disk, a DVD, or a Blu-Ray disk which is read by the CDD 30.

The removable medium may be a magneto-optical recording medium (for example, an MO) or a semiconductor recording medium (for example, a memory card).

The application program or data stored in the HDD 29 can also be stored in the removable medium 31 for use. Reference sign 20 denotes a transmission bus (an address bus, a data bus, an input/output bus, and a control bus) for connecting the aforementioned constituent units.

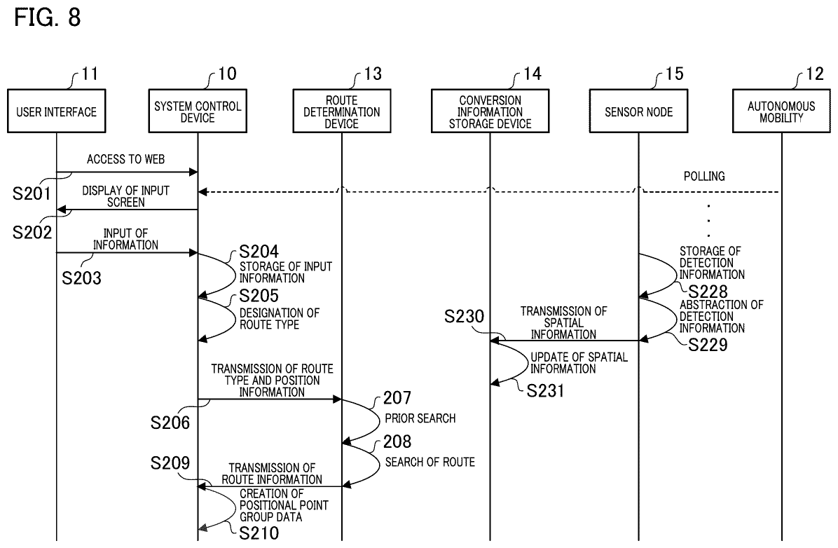

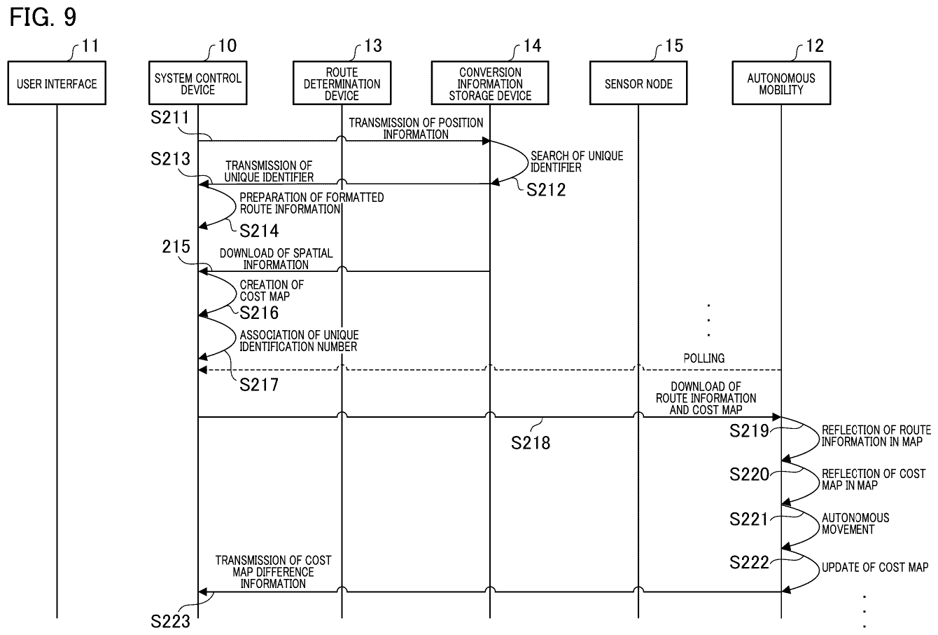

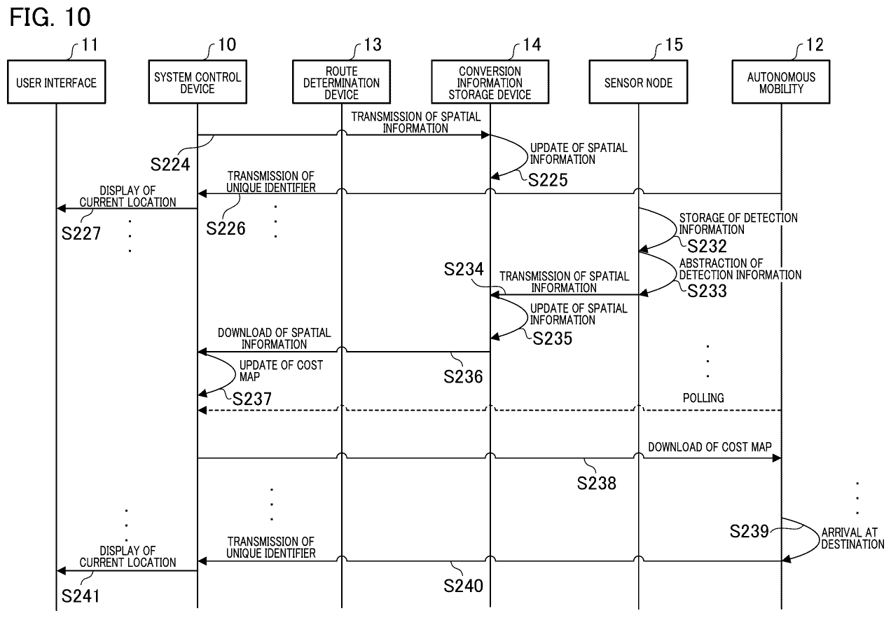

Details of a control operation in the autonomous mobility control system for realizing the route setting application or the like description above with reference to FIGS. 2 and 3 will be described below with reference to FIGS. 8 and 10. FIG. 8 is a sequence diagram illustrating a process flow that is performed by the autonomous mobility control system according to the first embodiment, FIG. 9 is a sequence diagram subsequent to FIG. 8, and FIG. 10 is a sequence diagram subsequent to FIG. 9.

FIGS. 8 and 10 illustrate processes that are performed by the constituent devices until current location information of the autonomous mobility 12 is received after a user has input the position information to the user interface 11. Step operations of the sequences illustrated in FIGS. 8 to 10 are performed by causing a computer in the control unit of each device to execute a computer program stored in a memory thereof.

First, in Step S201, a user accesses a WEB page provided by the system control device 10 using the user interface 11. In Step S202, the system control device 10 displays a position input screen described above with reference to FIG. 2 on a display screen of the WEB page. In Step S203, as described above with reference to FIG. 2, the user selects an autonomous mobility (mobility) and inputs position information indicating a departure point, waypoints, and a destination (hereinafter, referred to as position information).

The position information may be words for designating a specific place (hereinafter, referred to as positional words) such as a building name, a station name, or an address, or a method of designating a specific position on a map displayed in the WEB page as a point (hereinafter, referred to as a point) may be used.

In Step S204, the system control device 10 stores type information of the selected autonomous mobility 12 and input information such as the input position information. At this time, when the position information is positional words, the positional words are stored. When the position information is the point, latitude/longitude corresponding to the point is searched for on the basis of the simple map information stored in the position/route information managing unit 10-3, and the latitude/longitude is stored.

Then, in Step S205, the system control device 10 designates a type of a route along which the mobility is movable (hereinafter, referred to as a route type) from the mobility type (type) of the autonomous mobility 12 designated by the user. Then, in Step S206, the system control device 10 transmits the route type along with the position information to the route determination device 13.

The mobility type is a type of a mobility which is locally distinguished as described above and refers to a type such as an automobile, a bicycle, or a drone. The route type is, for example, a regular road, an expressway, or a motorway for an automobile and is a predetermined walkway, a roadside strip of a regular road, or a bicycle lane for a bicycle.

In Step S207, the route determination device 13 inputs the received position information as a departure point, waypoints, and a destination to map information stored therein. When the position information is positional words, the route determination device 13 searches the map information using the positional words and uses the corresponding latitude/longitude information. When the position information is latitude/longitude information, the route determination device 13 inputs the position information without any change to the map information for use. The route determination device 13 may additionally perform prior search for a route.

Subsequently, in Step S208, the route determination device 13 searches for a route from the departure point to the destination via the waypoints. At this time, the route is searched for on the basis of the route type. Then, in Step S209, the route determination device 13 outputs the route from the departure point to the destination via the waypoints (hereinafter, referred to as route information) as a search result in a GPS exchange (GPX) format and transmits the route to the system control device 10.

A file in the GPX format mainly includes three types including waypoints (point information without an ordering relation), a route (point information with an ordering relation having time information added thereto), and a track (an information set of a plurality of points: a trajectory).

Latitude/longitude is described as attribute values of point information, and a height above sea level or a geoid height, a GPS receiving situation and precision, and the like are described as child elements. Minimum elements required for the GPX file is latitude/longitude of a single point, and description of other information is arbitrary. The route is output as the route information and is a set of point information including the latitude/longitude having an ordering relation. The route information may having another type as long as it can satisfy the above description.

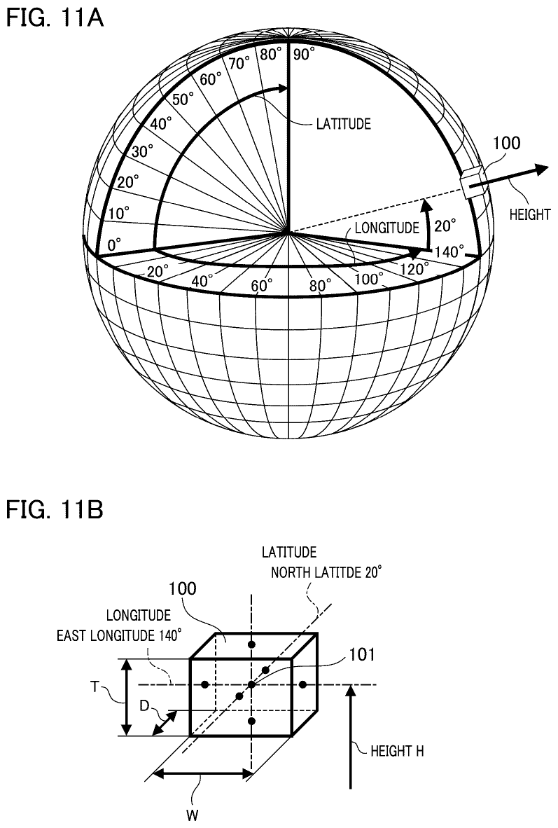

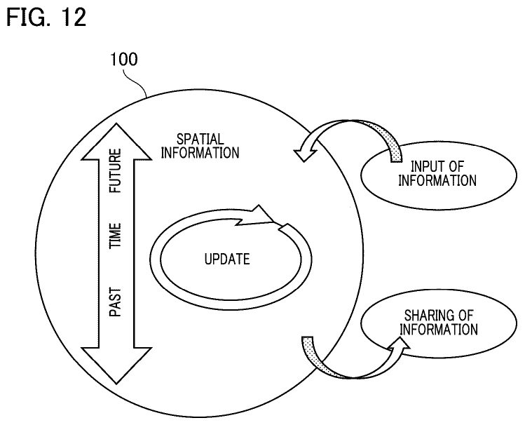

An example of a configuration of a format managed by the format database 14-4 of the conversion information storage device 14 will be described below in detail with reference to FIGS. 11A and 11B and FIG. 12.

FIG. 11A is a diagram illustrating latitude and longitude information of the global, and FIG. 11B is a perspective view illustrating a predetermined space 100 in FIG. 11A. The center of the predetermined space 100 in FIG. 11B is defined as a center 101. FIG. 12 is a diagram schematically illustrating spatial information in the space 100.

In the format illustrated in FIGS. 11A and 11B, the global space is divided into three-dimensional spaces which are determined by ranges with latitude, longitude, and height as an origin, and unique identifiers are added to the sub spaces, which make the sub spaces manageable. For example, a space 100 is displayed as a predetermined three-dimensional space.

The center 101 of the space 100 is a divided space that is defined by north latitude 20°, east longitude 140°, and height (altitude, height above sea level) H and in which a width in the latitude direction is D, a width in the longitude direction is W, and a width in the height direction is T. The space 100 is a sub area when the global space is divided into sub spaces determined by ranges with latitude, longitude, and height as an origin.

In FIG. 11A, for the purpose of convenience, only the space 100 is illustrated, but it is assumed that spaces which are defined in the same way as the space 100 are arranged in the latitude, longitude, and height directions in definition of the format. It is also assumed that horizontal positions of the arranged sub spaces are defined by latitude and longitude, the sub spaces are stacked in the height direction, and positions in the height directions are defined by heights.

In FIG. 11B, the center 101 of the sub space is set as an origin of the latitude, longitude, and height, but the present invention is not limited thereto. For example, a corner of the sub space or the center of the bottom may be set as the original. The sub area can have a substantially rectangular parallelepiped shape, and when it is considered that the sub spaces spread all over a spherical surface such as the earth, the top surface of each rectangular parallelepiped can be preferably set to be wider than the bottom surface thereof such that the sub spaces can be more compactly arranged.

In an example of a space 100 illustrated in FIG. 12, information (spatial information) on types of objects which are present in or can enter a range of the space 100 and time limit thereof is formatted and stored in the format database 14-4 in association (correlation) with unique identifiers. Formatted spatial information is stored in a time series from the past to the future. In the following description, correlation and association are used in the same meaning.

That is, the conversion information storage device 14 formats and stores spatial information on types of objects which are present in or can enter a three-dimensional space defined by latitude, longitude, and height and time limit thereof in the format database 14-4 in association with unique identifiers.

The spatial information is updated at predetermined update intervals on the basis of information supplied from an information supply unit such as an external system (for example, the sensor node 15) communicatively connected to the conversion information storage device 14. The spatial information is shared by another external system communicatively connected to the conversion information storage device 14. In usage without requiring information on time, spatial information not including information on time can also be used. Nonunique identifiers may be used instead of unique identifiers.

As described above, in the first embodiment, information (hereinafter, referred to as (spatial information) on types of objects which are present in or can enter a three-dimensional space defined by latitude, longitude, and height and time limit thereof is formatted and stored in a database in association with unique identifiers. Time and space can be managed using the formatted spatial information.

The conversion information storage device 14 according to the first embodiment performs a formatting step of formatting and storing information on the update intervals of the spatial information in association with the unique identifiers. Information on the update intervals which are formatted in association with the unique identifiers may be an update frequency, the information on the update intervals includes the update frequency.

Referring back to FIG. 8, the process flow that is performed by the autonomous mobility control system will be continuously described. In Step S210, the system control device 10 ascertains intervals between the point information in the received route information. Then, the system control device 10 creates data in which the intervals of the point information are matched with intervals between origin positions of the sub spaces defined in the format as positional point group data.

At this time, when the interval of the point information is less than the interval between the origin positions of the sub spaces, the system control device 10 creates the positional point group data by thinning out point information in the route information according to the interval between the origin positions of the sub spaces. When the interval of the point information is greater than the interval between the origin positions of the sub spaces, the system control device 10 creates the positional point group data by interpolating the point information without departing from the route information.

Then, as indicated by Step S211 of FIG. 9, the system control device 10 transmits the latitude/longitude information of the point information in the positional point group data to the conversion information storage device 14 in the order of the route. The conversion information storage device 14 searches the format database 14-4 for unique identifiers corresponding to the received latitude/longitude in Step S212 and transmits the unique identifiers to the system control device 10 in Step S213.

In Step S214, the system control device 10 arranges the received unique identifiers in the same order as the original positional point group data and stores route information using the unique identifiers (hereinafter, referred to as formatted route information). In this way, in Step S214, the system control device 10 which is a route generation unit acquires spatial information of the database of the conversion information storage device 14 and generates route information on a moving route of a mobility (mobile object) on the basis of the acquired spatial information and type information of the mobile object.

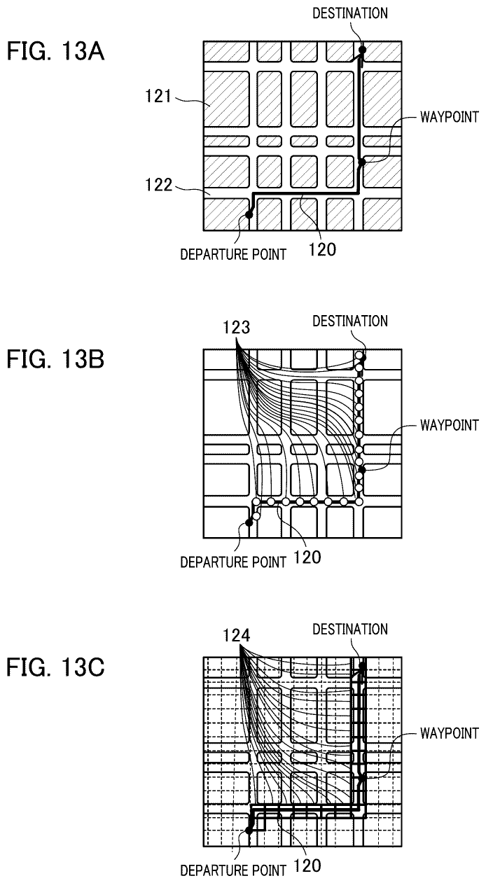

A process of generating the positional point group data from the route information and converting the positional point group data to route information using unique identifiers will be described below in detail with reference to FIGS. 13A, 13B, and 13C. FIG. 13A is a conceptual diagram illustrating route information displayed on map information, FIG. 13B is a conceptual diagram illustrating route information using positional point group data displayed on map information, and FIG. 13C is a conceptual diagram illustrating route information using unique identifiers displayed on map information.

In FIG. 13A, reference sign 120 denotes route information, reference sign 121 denotes a movement-prohibited area through which an autonomous mobility 12 cannot pass, and reference sign 122 denotes a movement-permitted area through which an autonomous mobility 12 can move. The route information 120 generated by the route determination device 13 on the basis of position information of the departure point, the waypoints, and the destination designated by the user is generated as a route passing through the departure point, the waypoints, and the destination and passing through the movement-permitted area 122 on map information.

In FIG. 13B, reference sign 123 denotes a plurality of pieces of position information in the route information. The system control device 10 acquiring the route information 120 generates the position information 123 arranged at predetermined intervals in the route information 120.

The position information 123 can be expressed by latitude/longitude/height, and the position information 123 is referred to as positional point group data in the first embodiment. Then, the system control device 10 transmits the position information 123 (the latitude/longitude/height of each point) to the conversion information storage device 14 and converts the position information to unique identifiers.

In FIG. 13C, reference sign 124 denotes positional spatial information obtained by converting the position information 123 to the unique identifiers piece by piece and expressing a space range defined by each unique identifier with a rectangular frame. By converting the position information to the unique identifiers, the positional spatial information 124 is obtained. Accordingly, a route indicated by the route information 120 is expressed through conversion to the continuous positional spatial information 124.

Each piece of positional spatial information 124 is associated with information on types of objects which are present or can enter the space range and time limit thereof. The continuous positional spatial information 124 is referred to as formatted route information in the first embodiment.

Description of the process flow that is performed by the autonomous mobility control system referring back to FIG. 9 will be continued. In Step S215 subsequent to Step S214, the system control device 10 downloads the spatial information associated with the unique identifiers of the formatted route information from the conversion information storage device 14.

Then, in Step S216, the system control device 10 converts the spatial information to a format which can be reflected in the three-dimensional map in a cyber space of the autonomous mobility 12 and creates information indicating positions of a plurality of objects (obstacles) in a predetermined space (hereinafter, referred to as a cost map). The cost map may be created from the first time for all spaces of the route of the formatted route information or may be created using a method of creating a cost map in a sectioning manner with a predetermined area and sequentially updating the cost map.

Then, in Step S217, the system control device 10 stores the formatted route information and the cost map in association with a unique identification number (a unique identifier) allocated to the autonomous mobility 12.

The autonomous mobility 12 monitors its own unique identification number via a network (performs polling) at predetermined time intervals, and downloads the associated cost map in Step S218. The autonomous mobility 12 reflects the latitude/longitude information of the unique identifiers in the formatted route information as route information in the three-dimensional map in a cyber space created by the autonomous mobility 12 in Step S219.

Then, in Step S220, the autonomous mobility 12 reflects the cost map as obstacle information on a route in the three-dimensional map in a cyber space. When the cost map is created in the form of sections at predetermined intervals, the autonomous mobility 12 downloads a cost map of the next area and updates the cost map after moving in the area of which the cost map has been created.

In Step S221, the autonomous mobility 12 moves while avoiding objects (obstacles) input to the cost map on the basis of the route information. That is, movement control is performed on the basis of the cost map.

At this time, in Step S222, the autonomous mobility 12 moves while detecting an object and moves while updating the cost map using the object detection information when there is a difference from the cost map. In Step S223, the autonomous mobility 12 transmits information of the difference from the cost map along with the corresponding unique identifier to the system control device 10.

The system control device 10 having acquired the unique identifier and the difference information from the cost map transmits the spatial information to the conversion information storage device 14 in Step S224 of FIG. 10, and the conversion information storage device 14 updates the spatial information of the corresponding unique identifier in Step S225.

Details of the spatial information which are updated do not reflect the difference information from the cost map without any change, but are made to be abstract by the system control device 10 and then transmitted to the conversion information storage device 14. Details of the abstraction will be described later.

The autonomous mobility 12 moving on the basis of the formatted route information transmits the unique identifier associated with a space through which the autonomous mobility 12 is currently passing to the system control device 10 whenever the autonomous mobility 12 passes through a sub space associated with each unique identifier in Step S226.

Alternatively, at the time of polling, the unique identifiers may be associated with the unique identification number of the autonomous mobility 12. The system control device 10 ascertains the current location of the autonomous mobility 12 in the formatted route information on the basis of the unique identifier information of the spaces received from the autonomous mobility 12.

By repeating Step S226, the system control device 10 can ascertain where the autonomous mobility 12 is currently located in the formatted route information. The system control device 10 may stop storing of the unique identifier of the space through which the autonomous mobility 12 has passed and thus it is possible to reduce storage data capacity of the formatted route information.

In Step S227, the system control device 10 creates the ascertainment screen 50 and the map display screen 60 described above with reference to FIGS. 2 and 3 on the basis of the ascertained current location information of the autonomous mobility 12 and displays the screen on the display screen of the web page. Whenever the autonomous mobility 12 transmits the unique identifier indicating the current location to the system control device 10, the system control device 10 updates the ascertainment screen 50 and the map display screen 60.

On the other hand, in Step S228 of FIG. 8, the sensor node 15 stores detection information in a detection range, makes the detection information abstract in Step S229, and transmits the detection information as the spatial information to the conversion information storage device 14 in Step S230. The abstraction is, for example, information indicating whether there is an object or whether a presence state of an object has changed, but is not detailed information of the object.

Detailed information on an object is stored in the memory of the sensor node. Then, in Step S231, the conversion information storage device 14 stores the spatial information which is the abstracted detection information in association with the unique identifier of the position corresponding to the spatial information. Accordingly, the spatial information is stored for one unique identifier in the format database.

When an external system other than the sensor node 15 uses the spatial information, the external system acquires and uses the detection information in the sensor node 15 via the conversion information storage device 14 on the basis of the spatial information in the conversion information storage device 14. At this time, the conversion information storage device 14 also has a function of linking communication standards of the external system and the sensor node 15.

By storing the spatial information in a plurality of devices as well as the sensor node 15 as described above, the conversion information storage device 14 has a function of linking data of the plurality of devices with a relatively small amount of data. When detailed object information is required for the system control device 10 to create the cost map in Steps S215 and S216 of FIG. 9, detailed information can be downloaded and used from the external system storing the detailed detection information of the spatial information.

Here, it is assumed that the sensor node 15 on the route of the formatted route information of the autonomous mobility 12 updates the spatial information. At this time, the sensor node 15 acquires the detection information in Step S232 of FIG. 10, generates abstract spatial information in Step S233, and transmits the abstract spatial information to the conversion information storage device 14 in Step S234. The conversion information storage device 14 stores the spatial information in the format database 14-4 in Step S235.

The system control device 10 ascertains change of the spatial information in the formatted route information to be managed at predetermined time intervals and downloads the spatial information in Step S236 when the spatial information has changed. Then, in Step S237, the system control device 10 updates the cost map associated with the unique identification number allocated to the autonomous mobility 12.

In Step S238, the autonomous mobility 12 recognizes updating of the cost map at the time of polling and reflects the updated cost map in the three-dimensional map in a cyber space created by the autonomous mobility 12.

As described above, by using the spatial information which is shared by a plurality of devices in advance, the autonomous mobility 12 can recognize change on a route which cannot be recognized by the autonomous mobility 12 and can cope with the change.

When the aforementioned series of system has been performed and the autonomous mobility 12 has arrived at the destination in Step S239, the autonomous mobility 12 transmits the unique identifier in Step S240.

Accordingly, the system control device 10 having recognized the unique identifier displays information indicating the arrival on the user interface 11 in Step S241 and ends the application.

According to the first embodiment, it is possible to provide a format of a digital architecture and an autonomous mobility control system using the format as described above.

As described above with reference to FIGS. 11A and 11B and FIG. 12, information (spatial information) on types of objects which are present in or can enter the range of the space 100 and time limit thereof is stored in a time series from the past to the future in the format database 14-4. The spatial information is updated on the basis of information input from an external sensor or the like communicatively connected to the conversion information storage device 14 and is shared by another external system communicatively connected to the conversion information storage device 14.

One of such spatial information is type information of an object in a space. Here, the type information of an object in the space is, for example, information that can be acquired from map information such as roadways, walkways, or bicycle ways on a road. Information such as a traveling direction of mobilities and traffic regulations in roadways can also be defined as the type information similarly. As will be described later, type information may be defined for a space itself.

Cooperative operations of the conversion information storage device 14, the system control device 10 for controlling an autonomous mobility 12, and the like have been described above with reference to FIG. 4. However, the conversion information storage device 14 can also be connected to a system control device for managing road information or a system control device for managing information of sections other than roads in addition the system control device 10.

That is, the system control device 10 can transmit positional point group data which is a generic term of the position information 123 illustrated in FIG. 13B to the conversion information storage device 14 as described above. Similarly, a system control device for managing road information or a system control device for managing information of sections other than roads can also transmit data corresponding thereto to the conversion information storage device 14.

The data corresponding thereto is information of positional point group data that is managed by a system control device for managing road information or a system control device for managing information of sections other than roads. It is assumed that each point of the positional point group data is referred to as a positional point.

After transmission, by storing the data in association with the unique identifiers of the format database 14-4 and appropriately updating the information, it is possible to accurately reflect current information in the real world in the conversion information storage device 14 and to prevent movement of the autonomous mobility 12 from being hindered.

In the first embodiment, the update interval of spatial information varies depending on types of objects present in the space. That is, when a type of an object present in the space is a mobile object, the update interval is set to be shorter than when a type of an object present in the space is not a mobile object. When a type of an object present in the space is a road, the update interval is set to be shorter than when a type of an object present in the space is a section.

When there is a plurality of objects in the space, the update interval of spatial information on each object is set to vary depending on a type of the object (for example, a mobile object, a road, or a section). Spatial information on states and time of a plurality of objects present in the space is formatted and stored in association with a unique identifier. Accordingly, it is possible to reduce a load for updating spatial information.

### Second Embodiment

As described above with reference to FIGS. 11A and 11B and FIG. 12, information (spatial information) on states of objects present in a spatial range and time is stored in a time series from the past to the future in the format database 14-4.

The spatial information is updated at predetermined intervals on the basis of information input from an external system (for example, the sensor node 15) or the like communicatively connected to the conversion information storage device 14 and is shared by another external system communicatively connected to the conversion information storage device 14. As described above, the conversion information storage device 14 can be connected to a network through wired communication or wireless communication.

In a second embodiment, spatial information is stored in association with voxels (VOXEL) with a cubic shape of spatial sub spaces which are obtained by dividing a spatial area in the real world. Spatial information may be stored in association with a three-dimensional spatial area with various shapes such as a rectangular parallelepiped shape, a polygonal shape, and a spherical shape in addition to a cubic shape.

Mobilities with various types/sizes such as an automobile, a truck, a drone, an aircraft, an automatic guided vehicle (AGV), and an autonomous mobile robot (AMR) are exemplified as an autonomous mobility of a user who uses spatial information in an autonomous mobility control system. It is assumed that a voxel size appropriate for use varies according to a type/size of the autonomous mobility, a use case, or the like. When sizes of all the voxels are the same, voxels with an appropriate size cannot be used according to a type/size of the autonomous mobility, a use case, or the like, which is poor in efficiency.

An example of a configuration of the format that is managed in a format database 14-4 of a conversion information storage device 14 according to the second embodiment will be described below. The second embodiment is different from the first embodiment in a sub space management method and has the same configuration as in the first embodiment except that.

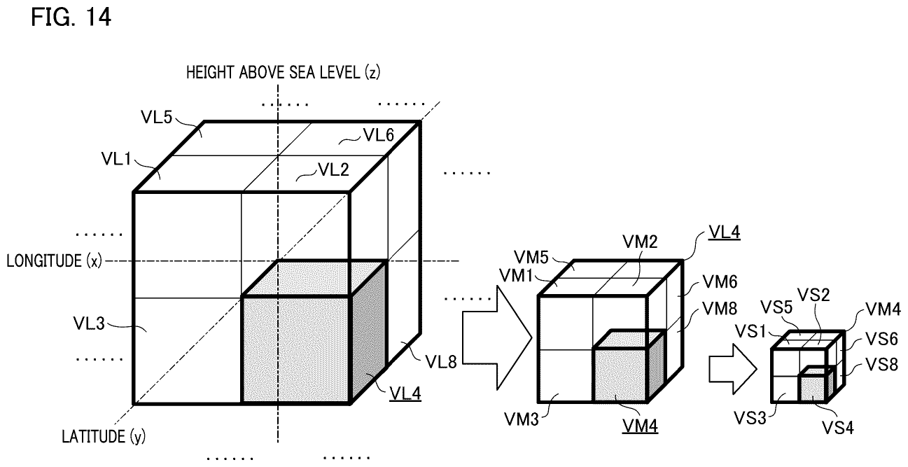

FIG. 14 is a diagram illustrating an example of a hierarchical structure of voxels according to the second embodiment. In a space, large voxels VL1, VL2, VL3, . . . , VL8 with a large size are arranged adjacent to each other in the directions of longitude (x), latitude (y), and altitude (z).

That is, a plurality of first spatial subareas (large voxels) with a first size (a large size) are arranged in a three-dimensional space defined by latitude, longitude, and height. Unique identifiers are allocated to the first spatial subareas, and the unique identifiers are stored in the format database 14-4 which is a storage unit. The control unit 14-3 stores spatial information on internal states of the plurality of first spatial subareas in the format database 14-4 in association with the corresponding unique identifiers.

A plurality of middle voxels with a middle size smaller than that of the large voxels, which are obtained by dividing (partitioning) a large voxel are arranged in each large voxel.

For example, middle voxels VM1, VM2, . . . , VM8 which are obtained by equally dividing the large voxel VL4 in the directions of longitude (x), latitude (y), and altitude (z) are arranged in the large voxel VL4. A plurality of small voxels with a small size smaller than that of the middle voxels which are obtained by dividing (partitioning) a middle voxel are arranged in each middle voxel.

For example, small voxels VS1, VS2, . . . , VS8 which are obtained by equally dividing the middle voxel VM4 in the directions of longitude (x), latitude (y), and altitude (z) are arranged in the middle voxel VM4.

A hierarchical structure of voxels in three levels of large, middle, and small is exemplified, but the number of levels may be two or four or more. For example, a plurality of micro voxels with a size smaller than that of the small voxels may be arranged in each small voxels, or a plurality of voxels with a size smaller than that of the micro voxels may be arranged in each micro voxel.

In this way, a plurality of second spatial subareas (middle voxels or small voxels) with a second size (a middle size or a small size) smaller than the first size are arranged in each first spatial subarea (each large voxel).

Unique identifiers are allocated to the second spatial subareas, and the unique identifiers are stored in the format database 14-4 which is a storage unit. The control unit 14-3 stores spatial information on internal states of the plurality of second spatial subareas in the format database 14-4 in association with the corresponding unique identifiers.

It has been described above that the large voxels are defined as the first spatial subareas and the middle voxels or the small voxels are defined as the second spatial subareas, but the large voxels or the middle voxels may be defined as the first spatial subareas and the small voxels may be defined as the second spatial subareas.

The voxels with different sizes have the same shape (similar shapes). The altitude (z) indicates a height from a reference plane/point and may be altitude with respect to the sea level or the ground level which is a reference plane. The height above the sea level/ground level may be set to a plus value. The height below the sea level/ground level may be set to a minus value. The height may be set to a height from a reference point which is the center of the earth.

The size of a large voxel is set to an arbitrary value such as 50 m or 100 m for each side. The sizes of all the large voxels in a space may be the same or may vary according to a position in the space. For example, the size of a large voxel on the ground and the sky thereof may be set to 50 m for each side, the size of a large voxel above the sea and the sky thereof in which objects are hardly present may be set to 100 m for each side, and the size of a large voxel under the sea and the ground may be set to 500 m for each side.

In this way, by setting a format of spatial subareas arranged in a space to a hierarchical structure, itis possible to selectively use voxels with appropriate sizes according to usage thereof. For example, in a use case in which a route of an autonomous mobility is determined, voxels with a size corresponding to a type or a size of an autonomous mobility which a route is determined such as an automobile, a truck, a drone, an aircraft, an automated guided vehicle (AGV), or an autonomous mobile robot (AMR) can be selected.

That is, voxels with a size corresponding to the size of an autonomous mobility for which a route is determined can be selected, for example, by selecting voxels with large sizes for a large autonomous mobility and selecting voxels with small sizes for a small autonomous mobility. Voxels with a large size corresponding to a width of a road of a moving route may be selected, for example, by selecting voxels with a large size for a place with a large road width and selecting voxels with a small size for a place with a small road width.

In a use case such as maintenance of a building, a road, or the like, voxels with a size corresponding to a size of cracks or corroded parts may be selected when cracks or corroded parts of the building, the road, or the like are maintained and repaired.

When only large voxels are arranged in a space, spatial information of the large voxels is used, for example, at the time of movement of a small autonomous mobility, and thus it may not be possible to determine an appropriate route or to determine a route with high precision.

When only small voxels are arranged in a space, spatial information of the large voxels is used, for example, at the time of movement of a small autonomous mobility, and thus it is necessary to process spatial information of many small voxels and thus there is a likelihood of an increase in processing load.

According to this embodiment, since voxels with appropriate sizes can be selected and used according to usage, it is possible to reduce a processing load, to determine an appropriate route, and to enhance convenience of information on a space.

A format database in which spatial information of large voxels is stored, a format database in which spatial information of middle voxels is stored, and a format database in which spatial information of small voxels is stored may be separately provided. In this case, the format database in which spatial information of voxels with an appropriate size is stored can be selectively used according to usage.

In Storage Examples 1 to 5 which will be described below, it is assumed that information on internal stages of voxels is acquired or generated and stored in the format database. In Storage Examples 1 to 3, it is assumed that object information on an object in each voxel (which includes information indicating whether there is an object) is stored as information on an internal state of each voxel in the format database.

Various types of information affecting movement of an autonomous mobility such as regulation information including information indicating whether there are regulations of traveling or flying in each voxel or construction information indicating whether there is construction in each voxel may be replaced with information on an object. In Storage Examples 4 and 5, it is assumed that weather information on the weather in each voxel is stored as information on an internal state of each voxel in the format database.

### Storage Example 1

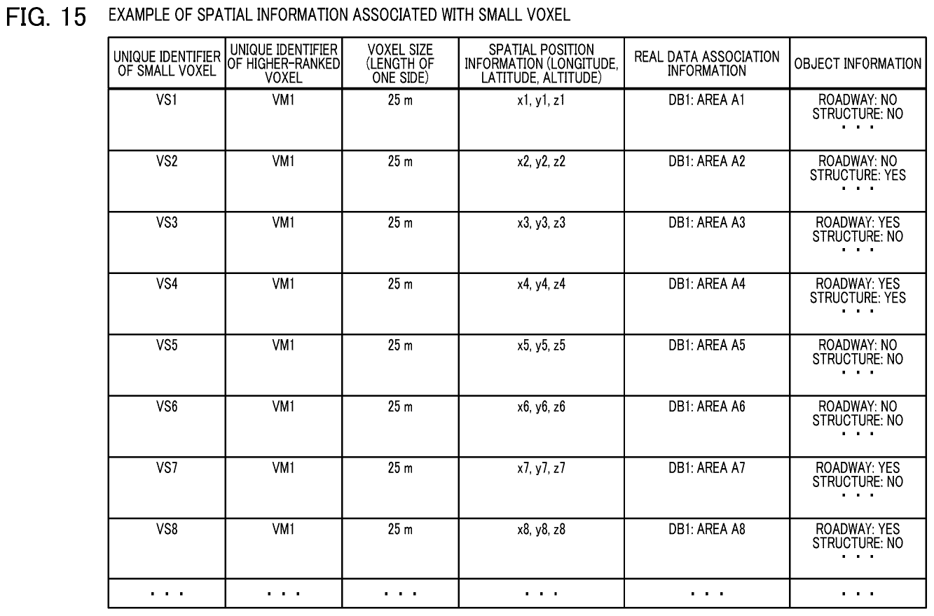

FIG. 15 is a diagram illustrating an example of spatial information associated with small voxels arranged in a space. Spatial information associated with each small voxel includes a unique identifier of each small voxel, a unique identifier of each higher-ranked voxel, a voxel size, spatial positional information (longitude, latitude, and altitude), real (actual) data (such as map data including object information) association information, and object information of each small voxel.

The unique identifier of each small voxel, the unique identifier of each higher-ranked voxel, the voxel size, the spatial positional information (longitude, latitude, and altitude), and the real data association information are stored in advance in the format database 14-4.

For example, for a small voxel VS1, VM1 as the unique identifier of a higher-ranked voxel, 25 m as the voxel size (a length of one side), longitude, latitude, and altitude (x1, y1, z1) of the center of a voxel as the spatial positional information are stored. A unique ID is allocated as the unique identifier of each small voxel such that the corresponding voxel can be identified in the space.

A unique identifier of a middle voxel in a higher rank including small voxels is stored as the unique identifier of a higher-ranked voxel. As the spatial positional information, the longitude, latitude, and altitude of the center of each small voxel are stored, but the longitude, latitude, and altitude of a vertex of the voxel may be stored.

As the real data association information, information (name: DB1, reference link: URL/URI, and the like) for identifying a map database which is an information source of real (actual) data including object information or area information (such as an area A1) indicating a predetermined range on a map of the map database is stored in advance.

It is assumed that a corresponding area on three-dimensional map data (preferably an area having the same shape and size as the corresponding voxel) in a map database corresponding to a voxel size of each voxel and the spatial positional information is associated with the unique identifier of the corresponding voxel in advance.

Preferably, in the map database, at least three-dimensional map data of longitude (x), latitude (y), and altitude (z) is stored, and four-dimensional map data additionally including the concept of time may be stored. Two-dimensional map data to which information on the height of an object on a structure in two-dimensional map data of longitude (x) and latitude (y) is added may be stored. The map database may be created by a private company or may be created by a public organization such as the Geographical Survey Institute.

For example, digital map (dynamic map) data in which dynamic information such as traffic regulation or construction information, accident or congestion information, pedestrian information, or signal information and stationary information such as three-dimensional information (such as road surface information, lane information, or structures) are combined may be stored.

3D city model data which is created by adding information in the height direction on the basis of two-dimensional map data used in a geographic information system (GIS) may be stored.

When the map database is first accessed, information for association with real (actual) data is not stored yet and thus the real data association information may be generated and stored in the format database 14-4 at the time of first access.

For example, the control unit 14-3 accesses an external map database via the network connection unit 14-6 and acquires position information and area information that are managed by the map database. The control unit 14-3 searches for and identifies a corresponding area (an area) on the map data of the map database corresponding to a size and spatial positional information of a voxel to be processed and generates real data association information.

The conversion information storage device 14 acquires object information, for example, from real (actual) data stored in an external map database (DB1) via the Internet 16 and stores the object information of positions corresponding to the small voxels VS1, VS2, . . . in association with the small voxels.

Specifically, the control unit 14-3 of the conversion information storage device 14 illustrated in FIG. 4 acquires object information from the external map database via the network connection unit 14-6. Then, the control unit 14-3 stores the object information corresponding to the small voxels VS1, VS2, . . . in the format database 14-4. The object information may be acquired from a sensor node 15 of a video monitoring system such as a roadside camera unit instead of the map database.

Information indicating whether there is a static object such as whether there is a roadway or whether there is a structure such as a building is stored as the object information of each voxel in the format database 14-4, and information indicating whether there is a dynamic object such as a vehicle or a pedestrian may be stored.

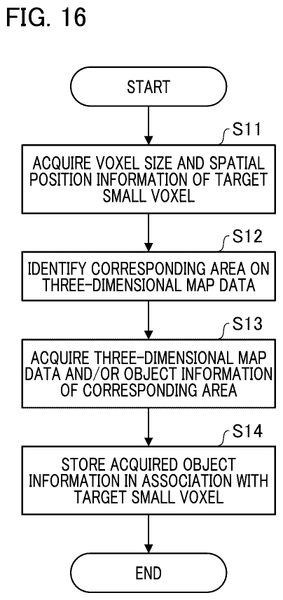

FIG. 16 is a flowchart illustrating a process flow of acquiring object information from the map database and storing the object information in association with small voxels. Step operations of the sequence illustrated in FIG. 16 are performed by causing a computer in the control unit 14-3 of the conversion information storage device 14 to execute a computer program stored in the memory thereof.

First, in Step S11, the control unit 14-3 of the conversion information storage device 14 acquires a voxel size and spatial positional information of a small voxel to be processed from the format database 14-4. For example, 25 m as the voxel size of the small voxel VS1 and the longitude, latitude, and altitude (x1, y1, z1) of the center of the small voxel VS1 as the spatial positional information are acquired.

Then, in Step S12, the control unit 14-3 acquires real data association information correlated with the small voxel VS1 to be processed in advance and identifies a corresponding area (an area A1) on map data corresponding to the voxel size and the spatial positional information of the small voxel VS1.

Then, in Step S13, the control unit 14-3 accesses the external map database via the network connection unit 14-6 and acquires map data and/or object information in the identified corresponding area from the map database. When the object information in the identified corresponding area on the three-dimensional map data is present, for example, as attribute information (meta data such as a shape or a position of a roadway or a structure), object information included in the attribute information can be acquired.

When the object information in the identified corresponding area on the three-dimensional map data is not present, for example, as attribute information, the control unit 14-3 acquires three-dimensional map data of the corresponding area, performs image analysis thereon, determines whether there is an object through object detection/object recognition, and acquires the object information.

Before Step S11, the control unit 14-3 may access the external map database and establish a connected state.

Then, in Step S14 (a control step), the control unit 14-3 stores the object information (railway: no, structure: no, and the like) acquired in Step S13 in the format database 14-4 in association (correlation) with the unique identifier of the small voxel VS1 to be processed.

By performing the same process on the small voxels VS2, VS3, . . . , object information corresponding to the small voxels is stored in the format database 14-4. Here, the processes of Steps S11 and S12 may be performed on a plurality of small voxels (for example, VS1 to VS8). Then, in Step S13, object information of a plurality of corresponding areas (for example, DB1: areas A1 to A8) corresponding to the plurality of small voxels (for example, VS1 to VS8) may be acquired together.

In this case, in Step S14, the object information of the plurality of corresponding areas (areas A1 to A8) acquired together in Step S13 is associated with the corresponding unit identifiers of the plurality of small voxels (for example, VS1 to VS8) to be processed. Thereafter, the resultant information can be stored in the format database 14-4.

The process flow illustrated in FIG. 16 may be performed at intervals of a preset period. At the time of second or later execution, previously stored information is updated. At the time of update, old information may be overwritten or old information may be left. Time information such as a time at which the information is stored in the format database 14-4 or a time at which the map database acquires/stores the information may be added to the spatial information.

The same processes as the processes performed on the small voxels in FIG. 16 may be performed on middle voxels and large voxels. In this case, the processes on the middle voxels/large voxels are the same as replacing the small voxels described above with reference with the operations of Steps S11 to S14 in FIG. 16 with the middle voxels/large voxels.

When the object information of the small voxel is acquired from the map database, it is necessary to access the map database via a network (such as an Internet public line) as described above with reference to FIG. 16. Since connection to a network is necessary, the process requires a process time, this process may require a long processing time when the processing load thereof is relatively high, the performance of the processor is low, and the like.

Accordingly, when it is intended to reduce the processing load, the object information of a middle voxels may be generated through a calculation process which will be described below on the basis of the acquired object information of the small voxels. Then, the object information of a large voxel may be generated through a calculation process which will be described below on the basis of the generated object information of the middle voxels. That is, spatial information of the higher-ranked first spatial subarea including a plurality of second spatial subareas may be generated on the basis of the spatial information of the plurality of second spatial subareas.

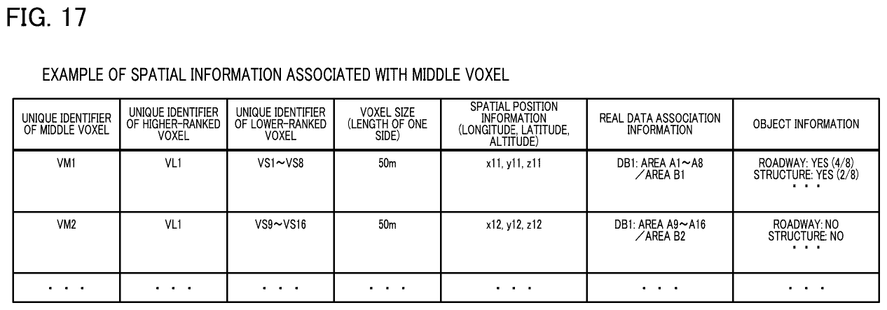

FIG. 17 is a diagram illustrating an example of spatial information associated with middle voxels arranged in a space. The spatial information associated with each middle voxel includes a unique identifier of each middle voxel, a unique identifier of a higher-ranked voxel, a unique identifier of each lower-ranked voxel, a voxel size, spatial positional information (longitude, latitude, and altitude), real data association information, and object information of each middle voxel.

In the format database 14-4, the unique identifier of each middle voxel, the unique identifier of a higher-ranked voxel, the unique identifiers of lower-ranked voxels, the voxel size, the spatial positional information (longitude, latitude, and altitude), and the real data association information are stored in advance.

In FIG. 17, for example, for a middle voxel VM1, VL1 as the unique identifier of a higher-ranked voxel, VS1 to VS8 as the unique identifiers of the lower-ranked voxels, and 50 m as the voxel size (a length of one side) are stored. Longitude, latitude, and altitude (x11, y11, z11) of the center of a voxel as the spatial positional information is also stored. A unique ID is allocated as the unique identifier of each middle voxel such that the corresponding voxel can be identified in the space.

A unique identifier of one higher-ranked large voxel including the middle voxels is stored as the unique identifier of a higher-ranked voxel. Unique identifiers of lower-ranked small voxels included in each middle voxel are stored as the unique identifiers of lower-ranked voxels. As the spatial positional information, the longitude, latitude, and altitude of the center of each middle voxel are stored, but the longitude, latitude, and altitude of a vertex of the voxel may be stored.

As the real data association information, information (name: DB1, reference link: URL/URI, and the like) for identifying a map database which is an information source of real (actual) data including object information, area information (such as an areas A1 to A8) indicating a predetermined range on the three-dimensional map, and the like are stored in advance. An area B1 including the areas A1 to A8 may be stored as the real data association information of the middle voxel VM1.

Then, the object information of the middle voxel VM1 (roadway: yes, structure: yes) is generated on the basis of the object information of the small voxels VS1 to VS8 as will be described below.

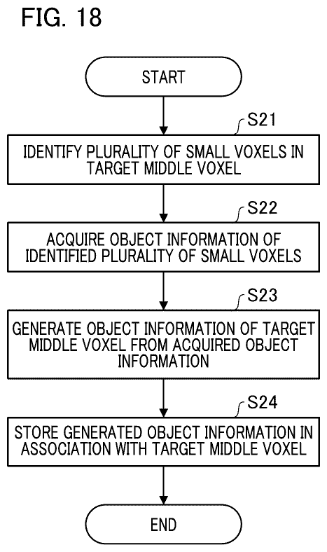

FIG. 18 is a flowchart illustrating a process flow of generating and storing object information of each middle voxel on the basis of object information of a plurality of small voxels. Step operations of the sequences illustrated in FIG. 18 are performed by causing a computer in the control unit 14-3 of the conversion information storage device 14 to execute a computer program stored in a memory thereof.

First, in Step S21, the control unit 14-3 of the conversion information storage device 14 acquires spatial information from the format database 14-4 and identifies a plurality of small voxels in the middle voxel to be processed. For example, a plurality of small voxels VS1 to VS8 in the middle voxel VM1 to be processed are identified. Then, in Step S22, the control unit 14-3 acquires object information of each of the plurality of identified small voxels VS1 to VS8.

Then, in Step S23, the control unit 14-3 generates object information of the middle voxel VM1 to be processed from the object information of the plurality of small voxels VS1 to VS8 acquired in Step S22. When at least one of the plurality of small voxels VS1 to VS8 is “roadway: yes,” the middle voxel VM1 is determined to be “roadway: yes.” When all of the small voxels VS1 to VS8 are “roadway: no,” the middle voxel VM1 is determined to be “roadway: no.”

When at least one of the plurality of small voxels VS1 to VS8 is “structure: yes,” the middle voxel VM1 is determined to be “structure: yes.” When all of the small voxels VS1 to VS8 are “structure: no,” the middle voxel VM1 is determined to be “structure: no.”

That is, when the spatial information of at least one of the plurality of second spatial subareas indicates that there is an object, the control unit 14-3 generates information indicating that there is an object as the spatial information of a higher-ranked first spatial subarea including the plurality of second spatial subareas. When the spatial information of all of the plurality of second spatial subareas indicates that there is no object, the control unit 14-3 generates information indicating that there is no object as the spatial information of the higher-ranked first spatial subarea including the plurality of second spatial subareas.

The control unit 14-3 may generate and store information indicating a proportion of “roadway: yes” and “structure: yes” in the plurality of small voxels VS1 to VS8.

For example, when eight small voxels VS1 to VS8 have the spatial information illustrated in FIG. 15, there are four small voxels of “roadway: yes,” and the proportion of “roadway: yes” of the middle voxel VM1 is 4/8 (=50%). In addition, there are two small voxels of “structure: yes” in the middle voxel VM1, and thus the proportion of “structure: yes” is 2/8 (=25%).

Then, in Step S24, the control unit 14-3 stores the object information of the middle voxel VM1 generated in Step S23 in the format database 14-4 in association with the middle voxel VM1 to be processed.

The process flow illustrated in FIG. 18 is performed subsequently to the process flow illustrated in FIG. 16, but may be periodically performed at intervals of a preset period. At the time of second or later execution, previously stored information is updated. At the time of update, old information may be overwritten or old information may be left. Time information such as a time at which the information is stored in the format database 14-4 or a time at which the map database acquires/stores the information may be added to the spatial information.

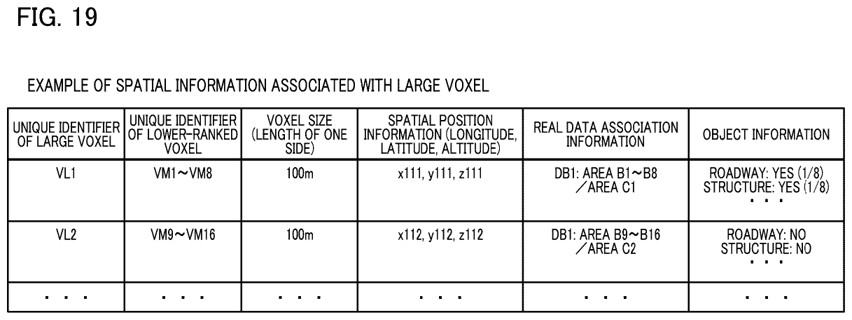

FIG. 19 is a diagram illustrating an example of spatial information associated with large voxels arranged in a space. The spatial information associated with each large voxel includes a unique identifier of each large voxel, unique identifiers of lower-ranked voxels, a voxel size, spatial positional information (longitude, latitude, and altitude), real data association information, and object information of each large voxel.

In the format database 14-4, the unique identifier of each large voxel, the unique identifiers of lower-ranked voxels, the voxel size, the spatial positional information (longitude, latitude, and altitude), and the real data association information are stored in advance.

In FIG. 19, for example, for a large voxel VL1, VM1 to VM8 as the unique identifiers of the lower-ranked voxels, 100 m as the voxel size (a length of one side) and longitude, latitude, and altitude (x111, y111, z111) of the center of a voxel as the spatial positional information are stored. A unique ID is allocated as the unique identifier of the large voxel such that the corresponding voxel can be identified in the space.

Unique identifiers of the lower-ranked middle voxels included in each large voxel are stored as the unique identifiers of the lower-ranked voxels. As the spatial positional information, the longitude, latitude, and altitude of the center of each large voxel are stored, but the longitude, latitude, and altitude of a vertex of the voxel may be stored.

As the real data association information, information (name: DB1, reference link: URL/URI, and the like) for identifying a map database which is an information source of real (actual) data including object information, area information (such as an areas B1 to B8) indicating a predetermined range on the three-dimensional map, and the like are stored in advance. An area C1 including the areas B1 to B8 may be stored as the real data association information of the large voxel VL1.

Then, the object information of the large voxel VL1 is generated on the basis of the object information of the middle voxels VM1 to VM8 as will be described below.

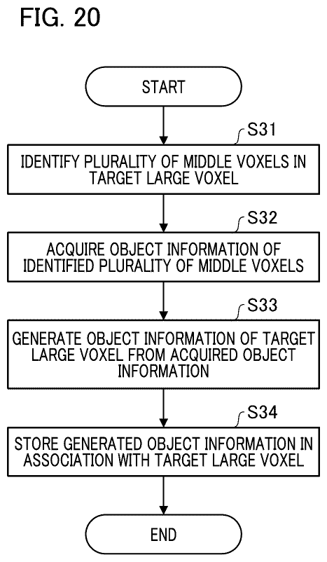

FIG. 20 is a flowchart illustrating a process flow of generating and storing object information of each large voxel on the basis of object information of a plurality of middle voxels. Step operations of the sequences illustrated in FIG. 20 are performed by causing a computer in the control unit 14-3 of the conversion information storage device 14 to execute a computer program stored in a memory thereof.

The operations of Steps S31 to S34 in FIG. 20 are the same as replacing the middle voxels in the operations of Steps S21 to S24 in FIG. 18 with the large voxels and replacing the small voxels with the middle voxels, and repeated description thereof will be omitted.

The process flow illustrated in FIG. 20 is performed subsequently to the process flow illustrated in FIG. 18, but may be periodically performed at intervals of a preset period. At the time of second or later execution, previously stored information is updated. At the time of update, old information may be overwritten or old information may be left. Time information such as a time at which the information is stored in the format database 14-4 or a time at which the map database acquires/stores the information may be added to the spatial information.

As described above, in Storage Example 1, after the object information of the small voxels have been acquired from the map database, the object information of the middle voxel is generated through a calculation process on the basis of the object information of the small voxels.

The object information of the large voxel is generated through a calculation process on the basis of the generated object information of the middle voxels. Accordingly, it is possible to efficiently acquire/generate the spatial information of the large voxels, the middle voxels, and the small voxels and to store the spatial information in the format database 14-4.

In this way, when the object information of a large voxel/middle voxel to be processed is generated from the object information of the voxels with a lower-ranked size than the voxel, it is not necessary to access an external database for a long time. Since a relatively simple calculation process is required, it is possible to relatively decrease the processing load, to decrease the processing time, and to enhance the efficiency.

### Storage Example 2

In Storage Example 1, the object information is stored from the lower-ranked voxel in the order of a small voxel, a middle voxel, and a large voxel. Storage Example 2 in which the object information is stored from the higher-ranked voxel in the order of a large voxel, a middle voxel, and a small voxel will be described below.

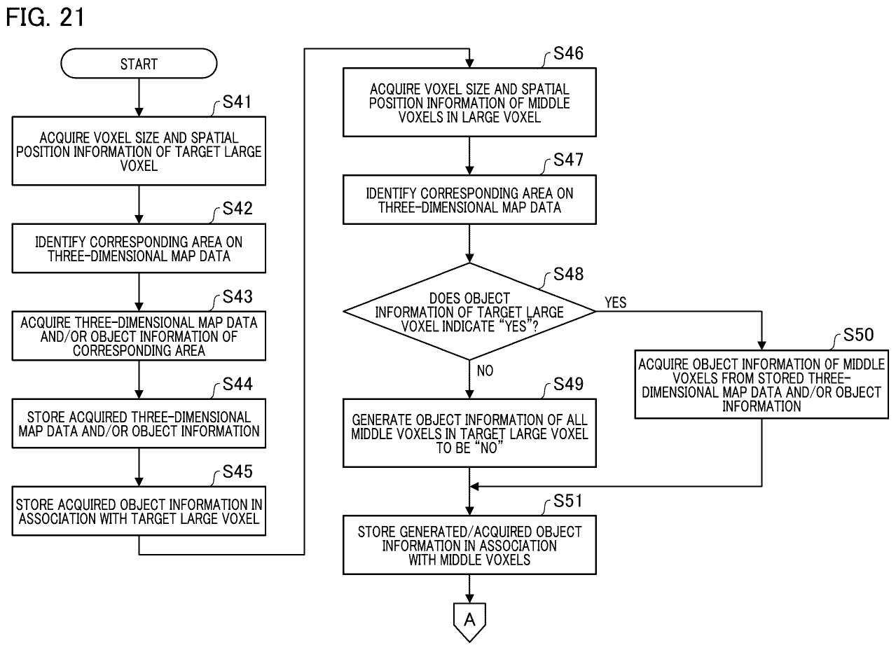

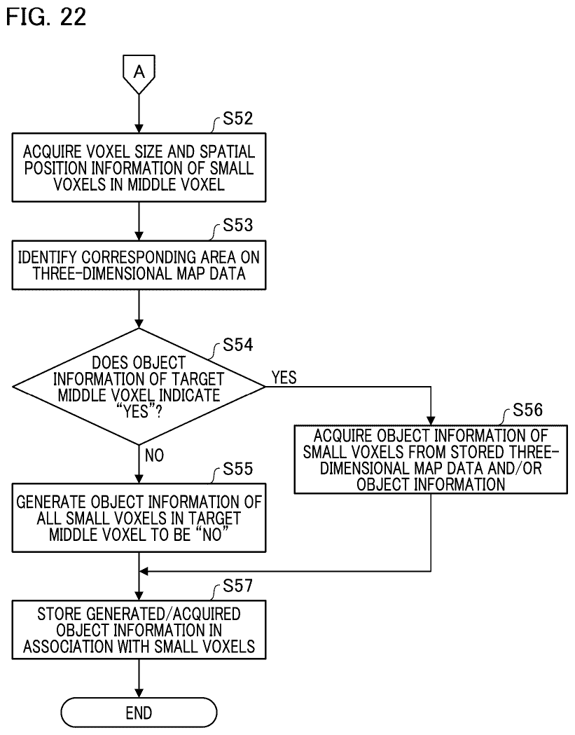

FIG. 21 is a flowchart illustrating a process flow of acquiring object information from the map database and storing the object information in association in the order of the large voxels, the middle voxels, and the small voxels, and FIG. 22 is a flowchart subsequent to FIG. 21. Step operations of the sequences illustrated in FIGS. 21 and 22 are performed by causing a computer in the control unit 14-3 of the conversion information storage device 14 to execute a computer program stored in the memory thereof.

The spatial information associated with each large voxel as illustrated in FIG. 19 can also be applied to this example. First, in Step S41, the control unit 14-3 of the conversion information storage device 14 acquires a voxel size and spatial positional information of a large voxel to be processed from the format database 14-4. For example, 100 m as the voxel size of the large voxel VL1 and the longitude, latitude, and altitude (x111, y111, z111) of the center of the large voxel VL1 as the spatial positional information are acquired.

Then, in Step S42, the control unit 14-3 acquires real data association information correlated with the large voxel VL1 to be processed in advance and identifies a corresponding area (an area C1) on three-dimensional map data corresponding to the voxel size and the spatial positional information of the large voxel VL1.

Then, in Step S43, the control unit 14-3 accesses the external map database via the network connection unit 14-6 and acquires three-dimensional map data and/or object information in the identified corresponding area from the map database. When the object information in the identified corresponding area on the three-dimensional map data is present, as attribute information (meta data such as a shape or a position of a roadway or a structure), object information included in the attribute information may be be acquired.

When the object information in the identified corresponding area on the three-dimensional map data is not present, as attribute information, the control unit 14-3 acquires the three-dimensional map data of the corresponding area, performs image analysis thereon, determines whether there is an object through object detection/object recognition, and acquires the object information.

Before Step S41, the control unit 14-3 may access the external map database and establish a connected state. Then, in Step S44, the control unit 14-3 temporarily stores the three-dimensional map data and/or the object information of the corresponding area acquired in Step S43 in the information storage unit 14-5.

Then, in Step S45, the control unit 14-3 stores the object information (railway: yes and structure: yes) acquired in Step S43 in the format database 14-4 in association with the large voxel VL1 to be processed.

Then, in Step S46, the control unit 14-3 acquires a voxel size and spatial positional information of each of a plurality of middle voxels VM1 to VM8 in the large voxel VL1 to be processed from the format database 14-4. The spatial information associated with the middle voxels as illustrated in FIG. 17 can also be applied to this example.

Then, in Step S47, the control unit 14-3 identifies corresponding areas (areas B1 to B8) on the three-dimensional map data corresponding to the voxel sizes and the spatial positional information of the plurality of middle voxels VM1 to VM8. When the position information and the area information managed in the map database and acquired in Step S42 are temporarily stored in the information storage unit 14-5, it is not necessary to access the external map database again in Step S47.

Then, in Step S48, the control unit 14-3 determines whether the object information of the large voxel VL1 to be processed is “roadway: yes.” In the example illustrated in FIG. 19, since the object information of the large voxel VL1 is “roadway: yes,” the determination result is YES and the process flow proceeds to Step S50. On the other hand, when it is “roadway: no” like the large voxel VL2, the determination result is NO and the process flow proceeds to Step S49. The process of determining whether there is an object is similarly performed on other object information such as a structure.

In Step S49, the control unit 14-3 generates object information of all the middle voxels in the large voxel to be processed by copying the object information of the large voxel (such as “roadway: no” and “structure: no” in the large voxel VL2).

In this way, the control unit 14-3 determines whether to generate spatial information on each object in a plurality of second spatial subareas in the first spatial subarea on the basis of the spatial information indicating whether there is an object in the first spatial subarea. That is, when the spatial information of the first spatial subarea indicates that there is no object, information indicating that there is no object is generated as the spatial information of the plurality of second spatial subareas in the first spatial subarea.

The processes of Steps S48 and S49 are performed on each piece of object information such as a roadway or a structure. For example, when the spatial information of the large voxel indicates “roadway: yes” and “structure: no,” the determination result of Step S48 for the object information of a roadway is YES and the process flow proceeds to Step S50. The determination result of Step S48 for the object information of a structure is NO and the process flow proceeds to Step S49.

In Step S50, the control unit 14-3 reads the three-dimensional map data and/or the object information stored in Step S44 from the information storage unit 14-5 and acquires the object information of the plurality of middle voxels VM1 to VM8.

In Step S51, the control unit 14-3 stores the object information generated or acquired in Step S49 or S50 in the format database 14-4 in association with the plurality of middle voxels VM1 to VM8 to be processed.

Then, in Step S52 of FIG. 22, the control unit 14-3 acquires a voxel size and spatial positional information of each of a plurality of small voxels VS1 to VS8 in the middle voxel VM1 to be processed from the format database 14-4. The spatial information associated with the small voxels as illustrated in FIG. 15 can also be applied to this example.

Then, in Step S53, the control unit 14-3 identifies corresponding areas (areas A1 to A8) on the three-dimensional map data corresponding to the voxel sizes and the spatial positional information of the plurality of small voxels VS1 to VS8. When the position information and the area information managed in the map database and acquired in Step S42 are temporarily stored in the information storage unit 14-5, it is not necessary to access the external map database again in Step S53.

Then, in Step S54, the control unit 14-3 determines whether the object information of the middle voxel VM1 to be processed is “roadway: yes.” In the example illustrated in FIG. 17, since the object information of the middle voxel VM1 is “roadway: yes,” the determination result is YES and the process flow proceeds to Step S56. On the other hand, when it is “roadway: no” like the middle voxel VM2, the determination result is NO and the process flow proceeds to Step S55. The process of determining whether there is an object is similarly performed on other object information such as a structure.

In Step S55, the control unit 14-3 generates object information of all the small voxels in the middle voxel to be processed by copying the object information of the middle voxel (such as “roadway: no” and “structure: no” in the middle voxel VM2).

In Step S56, the control unit 14-3 reads the three-dimensional map data and/or the object information stored in Step S44 from the information storage unit 14-5 and acquires the object information of each of the plurality of small voxels VS1 to VS8.

In Step S57, the control unit 14-3 stores the object information generated or acquired in Step S55 or S56 in the format database 14-4 in association with the plurality of small voxels VS1 to VS8 to be processed.

By performing the same processes on the large voxels VL2, VL3, . . . , the object information corresponding to the large voxels is stored in the format database 14-4. The object information corresponding to the middle voxels and the small voxels included in the large voxels VL2, VL3, . . . is stored in the format database 14-4.

The process flows illustrated in FIGS. 21 and 22 may be periodically performed at intervals of a preset period. At the time of second or later execution, previously stored information is updated. At the time of update, old information may be overwritten or old information may be left. Time information such as a time at which the information is stored in the format database 14-4 or a time at which the map database acquires/stores the information may be added to the spatial information.

As described above, in Storage Example 2, after the object information of a large voxel has been acquired from the map database, it is determined whether there is an object in the large voxel, and the object information of the middle voxels is generated or acquired. It is determined whether there is an object in the generated or acquired middle voxel, and the object information of the small voxels is generated or acquired. The process of copying the objection information “no” is very simple and it is possible to decrease the processing load.

Particularly, it is thought that most spaces in the sky include areas in which the object information is “no.” Accordingly, similarly to Storage Example 1, it is possible to efficiently acquire/generate spatial information of each large voxel, each middle voxel, and each small voxel and to store the spatial information in the format database 14-4.

Large voxels, middle voxels, and small voxels in a hierarchical structure are arranged in a space in advance, but only the large voxels may be arranged in advance in the space and then the lower-ranked voxels may be adaptively arranged according to necessity. For example, when the object information of a large voxel is “yes,” a plurality of middle voxels may be generated and arranged by dividing (partitioning) the large voxel.

In a middle voxel of which the object information is “yes,” a plurality of small voxels may be generated and arranged by dividing (partitioning) the middle voxel. That is, when the object information is “yes,” the corresponding voxel can be subdivided and in which voxel there is an object can be determined. When the object information is “no,” subdivision is not necessary and thus it is possible to reduce the processing load.

### Storage Example 3

In Storage Example 1, the object information is stored in the order of a small voxel, a middle voxel, and a large voxel. In Storage Example 2, the object information is stored in the order of a large voxel, a middle voxel, and a small voxel. In Storage Example 3, object information of a middle voxel is first stored and then object information of a large voxel or a small voxel is stored. That is, Storage Example 3 is realized by combining Storage Example 1 and Storage Example 2.

The operation of storing the object information of the middle voxel is the same as replacing the large voxel in Steps S41 to S45 in FIG. 21 with a middle voxel, and the same processes as the operations of Steps S52 to S57 in FIG. 22 are performed and the object information of the small voxel is stored.

Then, subsequently to Step S57, the object information of a large voxel can be stored by performing the same operations as the operations of Steps S31 to S35 in FIG. 20. In Storage Example 3, the same advantageous effects as in Storage Example 1 and Storage Example 2 are obtained.

Storage Example 1, Storage Example 2, and Storage Example 3 may be adaptively selectively performed according to a position in the space. For example, Storage Example 2 may be applied to the sky or underground in which the object information of most areas is “no,” Storage Example 1 may be applied to the space above the ground in which the object information of many areas is “no,” and Storage Example 3 may be applied to other areas.

### Storage Example 4

In Storage Examples 1 to 3, the object information on an object in each voxel is stored in the format database. In Storage Example 4, an example in which weather information on the weather in each voxel is stored in the format database will be described.

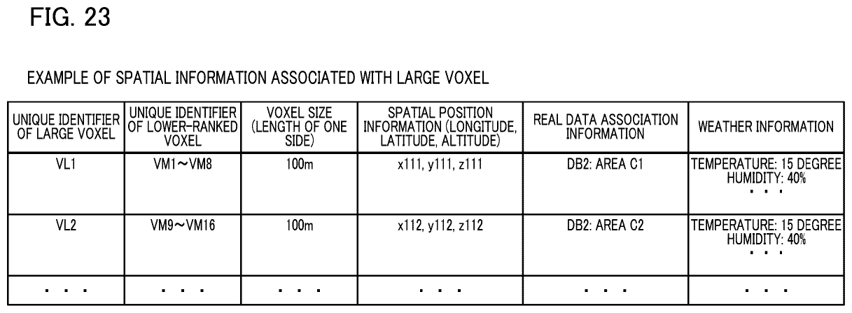

FIG. 23 is a diagram illustrating an example in which weather information is included as spatial information associated with each large voxel arranged in a space. The spatial information associated with each large voxel includes a unique identifier of each large voxel, unique identifiers of lower-ranked voxels, a voxel size, spatial positional information (longitude, latitude, and altitude), real data association information, and weather information in each large voxel.

Storing of the unique identifier of each large voxel, the unique identifiers of lower-ranked voxels, the voxel size, the spatial positional information (longitude, latitude, and altitude), and the real data association information is the same as in Storage Examples 1 to 3.

As the real data association information, information (name: DB2, reference link: URL/URI, and the like) for identifying a weather information database which is an information source of real (actual) data or area information (such as an area C1) indicating a predetermined range in a three-dimensional space of the weather information database are stored in advance.

It is assumed that a corresponding area in the three-dimensional space (preferably an area having the same shape and size as the corresponding voxel) in the weather information database corresponding to the voxel size and the spatial positional information of each voxel is associated with the unique identifier of the corresponding voxel in advance.

It is preferably assumed that weather information including the concept of time in a three-dimensional space of longitude (x), latitude (y), and altitude (z) is stored in the weather information database. For example, predicted weather information in the future and the past weather information in addition to the current weather information may be stored. Weather information on two-dimensional map data of longitude (x) and latitude (y) may be stored.

It is assumed that weather information such as temperature, humidity, precipitation probability, precipitation, wind direction, and wind speed is stored in the weather information database. The weather information database may be created by a private company or may be created by a public organization such as the Meteorological Administration.

When the weather information database is accessed at the first time, information for association with real (actual) data is not stored yet, and thus real data association information can be generated and stored in the format database at the first time of access. For example, the control unit 14-3 accesses an external weather information database via the network connection unit 14-6 and acquires position information and area information managed in the weather information database.

Then, the control unit 14-3 searches for and identifies a corresponding area (an area) in the three-dimensional space of the weather information database corresponding to the voxel size and the spatial positional information of the voxel to be processed and generates the real data association information.

The conversion information storage device 14 acquires weather information, for example, from real (actual) data stored in the external weather information database via the Internet 16. Then, the conversion information storage device 14 stores the weather information on the weather at positions corresponding to the large voxels VL1, VL2, . . . in association with the large voxels.

Specifically, the control unit 14-3 of the conversion information storage device 14 illustrated in FIG. 4 acquires the weather information from the external weather information database via the network connection unit 14-6. Then, the control unit 14-3 stores the weather information on the weather corresponding to the large voxels VL1, VL2, . . . in the format database 14-4.

Here, the weather information may be acquired from a sensor node 15 of a weather monitoring unit installed at each position instead of the weather information database. It is assumed that information such as temperature, humidity, precipitation probability, precipitation, wind direction, and wind speed is stored as the weather information in the format database 14-4.

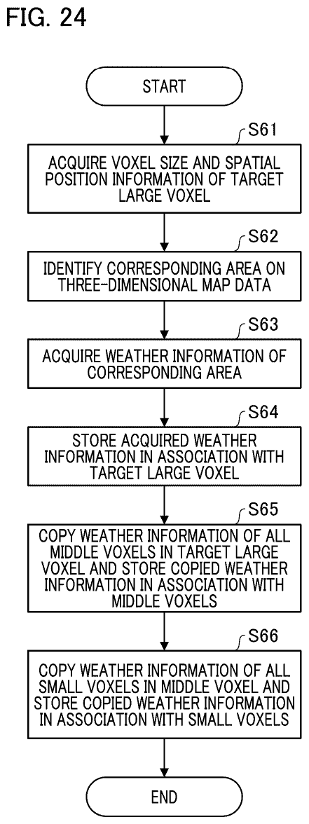

FIG. 24 is a flowchart illustrating a process flow of acquiring weather information from the weather information database and storing the weather information in association the large voxels, the middle voxels, and the small voxels. Step operations of the sequence illustrated in FIG. 24 are performed by causing a computer in the control unit 14-3 of the conversion information storage device 14 to execute a computer program stored in the memory thereof.

First, in Step S61, the control unit 14-3 of the conversion information storage device 14 acquires a voxel size and spatial positional information of a large voxel to be processed from the format database 14-4. For example, 100 m as the voxel size of the large voxel VL1 and the longitude, latitude, and altitude (x111, y111, z111) of the center of the large voxel VL1 as the spatial positional information are acquired.

Then, in Step S62, the control unit 14-3 acquires real data association information correlated with the large voxel VL1 to be processed in advance and identifies a corresponding area (an area C1) on three-dimensional map data corresponding to the voxel size and the spatial positional information of the large voxel VL1.

Then, in Step S63, the control unit 14-3 accesses the external map database via the network connection unit 14-6 and acquires weather information in the identified corresponding area from the weather information database. When the weather information in the identified corresponding area on the three-dimensional map data is present, for example, as attribute information (meta data such as temperature or humidity or other weather information correlated with a position in the three-dimensional space), object information included in the weather information can be acquired.

Before Step S61, the control unit 14-3 may access the external weather information database and establish a connected state.

Then, in Step S64, the control unit 14-3 stores the weather information (for example, temperature: 15 degrees and humidity: 40%) acquired in Step S63 in the format database 14-4 in association with the large voxel VL1 to be processed.

Then, in Step S65, the control unit 14-3 copies the weather information of the large voxel to be processed, generates the weather information of all the middle voxels in the large voxel to be processed, and stores the weather information in the format database 14-4 in association with the middle voxels. When the large voxel to be processed is the large voxel VL1, the temperature of 15 degrees, the humidity of 40%, and the like are stored as the weather information of the middle voxels VM1 to VM8.

That is, the control units 14-3 generates spatial information on the weather of a plurality of second spatial subareas in the first spatial subarea on the basis of the spatial information on the weather of the first spatial subarea. The control unit 14-3 generates spatial information on the weather of the plurality of second spatial subareas in the first spatial subarea by copying the spatial information on the weather of the first spatial subarea.

Subsequently, in Step S66, the control unit 14-3 copies the weather information of a middle voxel to be processed, generates the weather information of all small voxels in the middle voxel to be processed, and stores the weather information in the format database 14-4 in association with the small voxels. When the middle voxel to be processed is a middle voxel VM1, the temperature of 15 degrees, the humidity of 40%, and the like are stored as the weather information of each of the small voxels VS1 to VS8.

As described above, in Storage Example 4, after the weather information of a large voxel has been acquired from the weather information database, the weather information of the large voxel is copied, and the weather information of the middle voxels and the small voxels is generated. Accordingly, it is possible to efficiently acquire/generate spatial information of the large voxels, the middle voxels, and the small voxels and to store the spatial information in the format database 14-4.

When the weather information of a large voxel is acquired from the weather information database, it is necessary to access the weather information database via a network (an Internet public line) as described above with reference to FIG. 24.

A corresponding area on the three-dimensional map data in the weather information database corresponding to the large voxel to be processed is identified, and the weather information of the identified corresponding area is acquired. This process may require a long processing time when the processing load is relatively high, the performance of the processor is low, and the like.

If the weather information of all of the large voxels, the middle voxels, and the small voxels is acquired through access to the weather information database, the processing load is excessive and the processing time is increased. On the other hand, when the weather information of the middle voxels and the small voxels to be processed is generated by copying the weather information of the large/middle voxels with a higher-ranked size, it is not necessary to access an external database again. Since the process is relatively simple, it is possible to relatively decrease the processing load, to decrease the processing time, and to efficiently perform the process.

Since the weather information such as temperature, humidity, precipitation probability, precipitation, wind direction, and wind speed does not vary much according to a position in a space of the sky, for example, in a plain region, the precision of the spatial positions may be lower and the spatial position may be managed in units of the large voxels with a large size. Storage Example 4 can be applied to a type of information in which high precision of the spatial positions is not required in addition to the weather information.

### Storage Example 5

In Storage Example 4, the weather information is stored in the order of large voxels, middle voxels, and small voxels. However, for example, the weather information such as wind speed may require high precision of the spatial positions. In a region near high buildings in a city or the like, there is an area in which the wind direction or the wind speed varies according to positions. In a mountain region or the like, various types of weather information often vary according to the height above the seal level.

Accordingly, for the weather information such as the wind speed or in a mountain region or the like, the object information in Storage Example 1 may be replaced with the weather information and the weather information may be stored in the order of small voxels, middle voxels, and large voxels.

The object information in Storage Example 3 may be replaced with the weather information, the weather information of the middle voxels is first stored, and then the weather information of the large voxels or the small voxels may be stored. The storage method may be switched and performed adaptively according to a position in a space. In this case, the same advantageous effects as in Storage Example 1 or Storage Example 3 are obtained.

As described above, in the second embodiment, since voxels are configured in a hierarchical structure and the size of the voxels is changed according to the hierarchy, it is possible to select voxels with an optimal size according to usage. Accordingly, for example, it is possible to optimize the efficiency of a moving route of a mobile object.

### Third Embodiment

The method of setting voxels with arbitrary sizes has been described above in the second embodiment. However, in the description of the second embodiment, when a route of an autonomous mobility is set, existing voxel positions are fixed and thus there is a problem in that a route of the autonomous mobility passing through, for example, the center of a lane cannot be set.

This problem is a temporary problem when a route of an autonomous mobility is set and is not information which is semi-permanently stored. Thereafter, in the third embodiment, a method of setting a “virtual voxel” with an arbitrary size at an arbitrary position which is temporarily created and of which data is deleted later using the configurations according to the first embodiment and the second embodiment will be described.

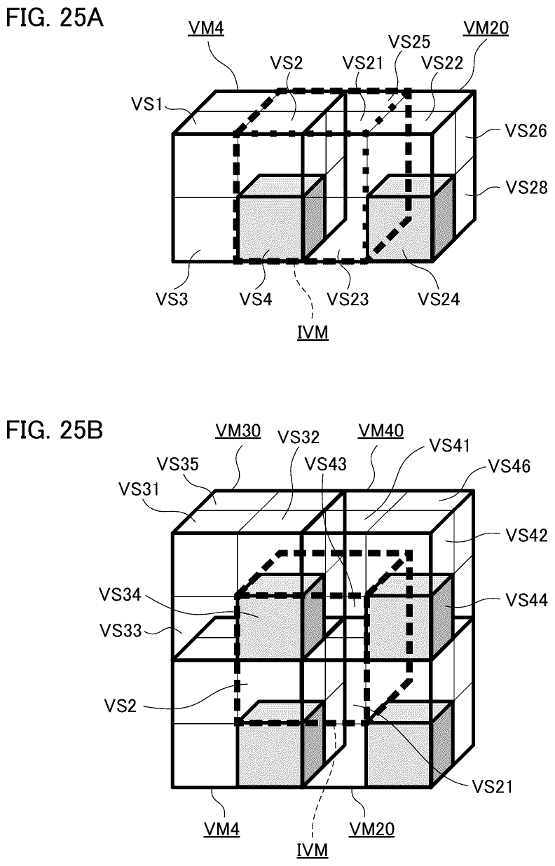

The method of setting a virtual voxel will be described below. Here, it is assumed that eight neighboring small voxels are arbitrarily selected and a virtual middle voxel is determined using them all. FIG. 25A is a diagram illustrating an example in which a plurality of small voxels included in two neighboring middle voxels in the hierarchical structure of voxels described in the second embodiment are selected and a virtual middle voxel IVM is determined.

In FIG. 25A, a middle voxels VM20 is arranged in the vicinity of a middle voxel VM4, and small voxels VS21, VS22, . . . , VS28 obtained by equally dividing the middle voxel VM20 in the directions of longitude (x), latitude (y), and altitude (z) are arranged therein.

Here, a virtual middle voxel IVM is generated from eight small voxels including the small voxels VS2, VS4, VS6, and VS8 in the middle voxel VM4 and the small voxels VS21, VS23, VS25, and VS27 in the middle voxel VM20.

FIG. 25B is a diagram illustrating an example in which a plurality of small voxels included in four neighboring middle voxels in the hierarchical structure of voxels described in the second embodiment are selected and a virtual middle voxel IVM is determined. Middle voxels VM20, VM30, and V40 are arranged in the vicinity of the middle voxel VM4.

The small voxels VS31, VS32, . . . , and VS38 obtained by equally dividing the middle voxel VM30 in the directions of longitude (x), latitude (y), and altitude (z) are arranged in the middle voxel VM30. The small voxels VS41, VS42, . . . , and VS48 obtained by equally dividing the middle voxel VM40 in the directions of longitude (x), latitude (y), and altitude (z) are arranged in the middle voxel VM40.

Here, the virtual middle voxel IVM is generated from eight small voxels including small voxels VS2 and VS6 in the middle voxel VM4, small voxels VS21 and VS25 in the middle voxel VM20, small voxels VS34 and VS38 in the middle voxel VM30, and small voxels VS43 and VS47 in the middle voxel VM40.

A plurality of virtual voxels which continuously neighbor each other may be generated in the same way as described above. The virtual middle voxel IVM is determined using eight small voxels when a virtual middle voxel is determined, but the present invention is not limited thereto, and a virtual large voxel IVL may be determined using eight middle voxels. A virtual voxel with an arbitrary size larger than the large voxel may be determined.

Similarly to the large, middle, and small voxels described above, unique identifiers are allocated to virtual voxels, and the unique identifiers are stored in the format database 14-4 which is a storage unit. The control unit 14-3 stores spatial information on internal states of a plurality of virtual voxels in the format database 14-4 in association with the unique identifiers.

For example, object information of each virtual middle voxel IVM is generated and stored on the basis of the flowchart illustrated in FIG. 18. Object information of each virtual large voxel IVL is generated and stored on the basis of the flowchart illustrated in FIG. 20.

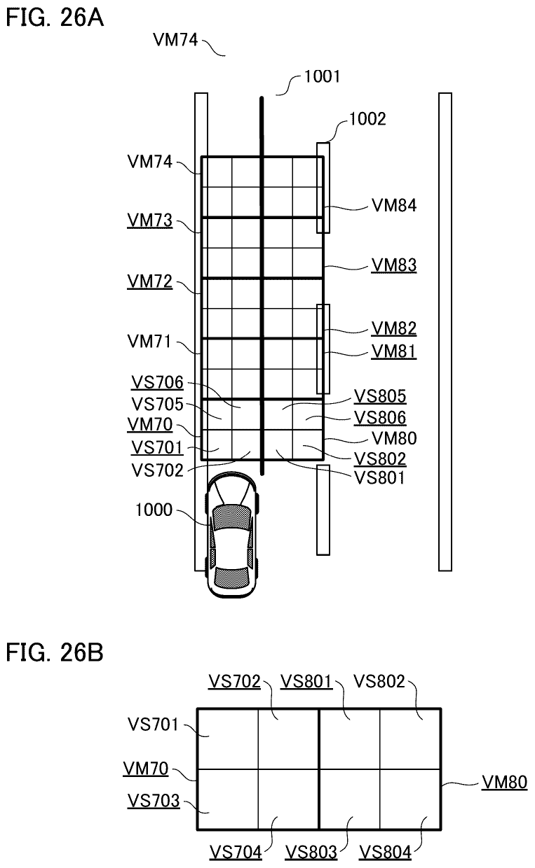

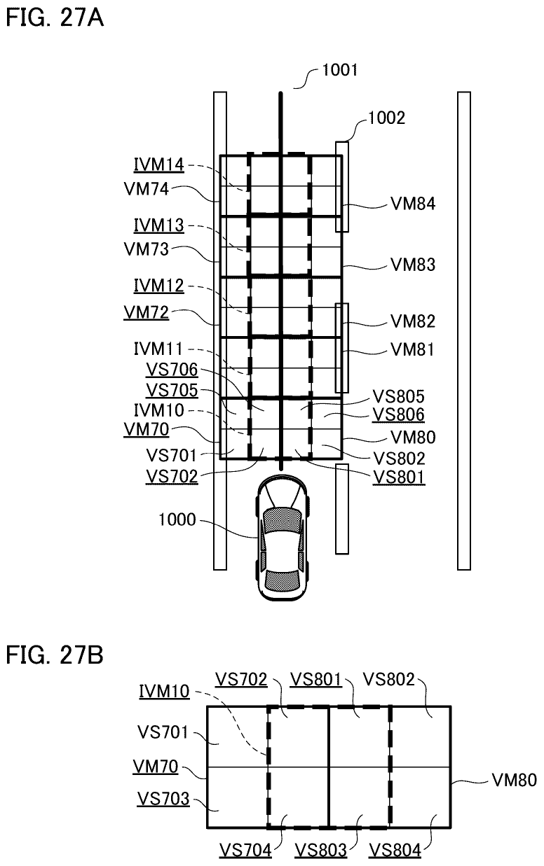

Subsequently, FIGS. 26A and 26B are diagrams illustrating an example of voxels which are arranged in a lane when an autonomous mobility moves, and FIGS. 27A and 27B are diagrams illustrating an example of virtual voxels are arranged on a center line of a lane 1001. A specific method of setting virtual voxels will be described with reference to FIGS. 26A and 26B and FIGS. 27A and 27B.

In FIGS. 26A and 27A, reference sign 1000 denotes an autonomous mobility, reference sign 1001 denotes a virtual center line of lanes of a road, reference sign 1002 denotes a central line of a road with two lanes on each side. Middle voxels VM70, VM71, . . . , VM74, VM80, VM81, . . . , VM84 are arranged on a road on which the autonomous mobility 1000 moves.

Small voxels VS701, VS702, . . . , VS708 obtained by equally dividing the middle voxel VM70 in the directions of longitude (x), latitude (y), and altitude (z) are arranged in the middle voxel VM70, and small voxels are arranged in the other middle voxels in the same way. It is assumed that the middle voxels extend continuously until the autonomous mobility 1000 arrives at a destination.

It is assumed that the centerline 1001 of a lane of a road is a virtual line connecting the centers of width information (for example, Lanelet) of the road acquired by the autonomous mobility 1000. The width information of the road may be included in the route determination device 13 or may be acquired from the outside via the Internet 16.

FIGS. 26B and 27B illustrate an example in which voxels are arranged when seen from the autonomous mobility 1000 in the traveling direction thereof. The autonomous mobility 1000 acquires predetermined voxel information at the time of movement and moves.

In FIG. 26A, the autonomous mobility 1000 acquires information of the middle voxels VM70, . . . , VM74 or the middle voxels VM80, . . . . VM84 which are arranged forward in the traveling direction and moves. However, in this case, the autonomous mobility 1000 moves along a left end of the lane, which is dangerous.

At the time of movement on a road, it is preferable that the autonomous mobility 1000 move while keeping the central position of a lane. Accordingly, in this case, it is possible to enhance safety of movement by arranging virtual voxels on the center line 1001 of the lane and causing the autonomous mobility to move with reference to the virtual voxels.

When the autonomous mobility 100 moves at the center of the road without arranging virtual voxels as illustrated in FIG. 26A, it is necessary to refer to voxels of a plurality of lines, an amount of data required for communication increases, and a delay time required for data communication also increases. However, in the example illustrated in FIG. 27A, by arranging virtual voxels on the center line 1001 of the lane, it is possible to decrease the number of lines of voxels to be referred to and to decrease the amount of data and the delay time required for data communication.

FIGS. 27A and 27B are diagrams illustrating an example of virtual voxels arranged on the center line 1001 of the lane. A virtual middle voxel IVM10 is generated by selecting small voxels VS702, VS704, VS706, and VS708 in a middle voxel VM70 and small voxels VS801, VS803, VS805, and VS807 in a middle voxel VM80 which are adjacent to the center line 1001 of the lane.

Similarly, virtual middle voxels IVM11, IVM12, and IVM13, . . . are generated, the autonomous mobility 1001 acquires information of the virtual middle voxels and moves to pass through the virtual middle voxels. Accordingly, the autonomous mobility 1001 can move on the center of the lane and thus it is possible to enhance safety.

The virtual voxel setting method when the autonomous mobility 1000 travels on the center of a lane has been described hitherto. The positions at which the virtual voxels are arranged are not limited to the lane center, and, for example, route setting using virtual voxels at arbitrary positions such as route setting in consideration of avoidance of an obstacle on a road or route setting in consideration of parking positions in a parking lot can be performed using the aforementioned methods according to situations.

As described above, according to the third embodiment, it is possible to set an optimal route and to achieve a decrease in an amount of communication data and a communication delay time by using virtual voxels to set a route of an autonomous mobility using voxels.

In the aforementioned description, the virtual voxels are stored in the format database 14-4, but the virtual voxels may be set by the system control device 10 using the method described above in this embodiment. At that time, the unique identifier managing unit 10-1 of the system control device 10 associates unique identifiers with the virtual voxels and stores the unique identifiers along with spatial information acquired from the format database 14-4 in the information storage unit (memory/HD) 10-4.

The virtual voxels described in this embodiment may be set as semi-permanent voxels. For example, when it is intended to acquire spatial information a corner of a building or the like along the building, virtual voxels can be selected and used according to the position of the corner of the building. At this time, deletion of the virtual voxels is not performed.

In the aforementioned embodiments, a control system is applied to an autonomous mobility (autonomous mobile object, or autonomous mobile body). However, a mobile object in these embodiments is not limited to an autonomous mobility such as an automated guided vehicle (AGV) or an autonomous mobile robot (AMR). For example, the mobile object includes any of an automobile, a train, a ship, an aircraft, a robot, and a drone may be employed as long as it is a mobile device which can move.

A part of the control system according to this embodiment may be mounted in a mobile object thereof or may not be mounted therein. This embodiment can also be applied to a case in which a mobile object is remotely controlled.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing system through a network or various storage media. Then, a computer (or a CPU, an MPU, or the like) of the information processing system may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

Priority is claimed on Japanese Patent Application No. 2022-014166, filed Feb. 1, 2022, Japanese Patent Application No. 2022-103849, filed Jun. 28, 2022, and Japanese Patent Application No. 2023-004385, filed Jan. 16, 2023. The whole contents of these Japanese patent applications are incorporated in this specification by reference.

What is claimed is:

1. An information processing device comprising:
at least one processor or circuit configured to function as:
a storage unit configured to store unique identifiers allocated to a plurality of first spatial subareas with a first size in a three-dimensional space and unique identifiers allocated to a plurality of second spatial subareas with a second size smaller than the first size in the first spatial subareas; and
a control unit configured to store spatial information on internal states of the plurality of first spatial subareas and the plurality of second spatial subareas in the storage unit in association with the corresponding unique identifiers.

2. The information processing device according to claim 1, wherein the control unit generates the spatial information of the first spatial subareas including the plurality of second spatial subareas on the basis of the spatial information of the plurality of second spatial subareas.

3. The information processing device according to claim 2, wherein, when the spatial information of at least one of the plurality of second spatial subareas indicates that there is an object, the control unit generates information indicating that there is an object as the spatial information of the first spatial subarea including the plurality of second spatial subareas.

4. The information processing device according to claim 2, wherein, when the spatial information of all the plurality of second spatial subareas indicates that there is no object, the control unit generates information indicating that there is no object as the spatial information of the first spatial subarea including the plurality of second spatial subareas.

5. The information processing device according to claim 1, wherein the control unit determines whether to generate the spatial information on an object in each of the plurality of second spatial subareas in the first spatial subarea on the basis of the spatial information on whether there is an object in the first spatial subarea.

6. The information processing device according to claim 5, wherein, when the spatial information of the first spatial subarea indicates that there is no object, the control unit generates information indicating that there is no object as the spatial information of each of the plurality of second spatial subareas in the first spatial subarea.

7. The information processing device according to claim 1, wherein the control unit generates the spatial information on the weather of each of the plurality of second spatial subareas in the first spatial subarea on the basis of the spatial information on the weather of the first spatial subarea.

8. The information processing device according to claim 7, wherein the control unit copies the spatial information on the weather of the first spatial subarea and generates the spatial information on the weather of each of the plurality of second spatial subareas in the first spatial subarea.

9. The information processing device according to claim 1, wherein the control unit stores information on an update interval of the spatial information in the storage unit in association with the corresponding unique identifier.

10. The information processing device according to claim 9, wherein the information on the update interval varies according to a type of an object present in the space.

11. The information processing device according to claim 10, wherein the information on the update interval when the type of the object present in the space is a mobile object is shorter than that when the type of the object present in the space is not a mobile object.

12. The information processing device according to claim 1, wherein the at least one processor or circuit is further configured to function as, a route generation unit configured to generate route information on a moving route of the mobile object on the basis of the spatial information stored in the storage unit and type information of a mobile object.

13. The information processing device according to claim 12, wherein the mobile object includes an autonomous mobility.

14. The information processing device according to claim 1, wherein the storage unit selects an arbitrary plurality of second spatial subareas with the second size and stores a unique identifier allocated to a virtual first spatial subarea with the first size, and
wherein the control unit stores spatial information on an internal state of the virtual first spatial subarea in the storage unit in association with the unique identifier.

15. An information processing method comprising:
storing unique identifiers allocated to a plurality of first spatial subareas with a first size in a three-dimensional space and unique identifiers allocated to a plurality of second spatial subareas with a second size smaller than the first size in the first spatial subareas; and
performing control such that spatial information on internal states of the plurality of first spatial subareas and the plurality of second spatial subareas is stored in association with the corresponding unique identifiers.

16. A non-transitory computer-readable storage medium configured to store a computer program comprising instructions for executing following processes:
storing unique identifiers allocated to a plurality of first spatial subareas with a first size in a three-dimensional space and unique identifiers allocated to a plurality of second spatial subareas with a second size smaller than the first size in the first spatial subareas; and
performing control such that spatial information on internal states of the plurality of first spatial subareas and the plurality of second spatial subareas is stored in association with the corresponding unique identifiers.
